(19) United States
(12) Patent Application Publication
(10) Pub. No.: US 2019/0138308 A1
(43) Pub. Date: May 9, 2019

(54) UNALIGNED MEMORY ACCESSES

(71) Applicant: MIPS Tech, LLC, Santa Clara, CA (US)

(72) Inventors: James Hippisley Robinson, New York, NY (US); Morgyn Taylor, San Jose, CA (US); Richard Fuhler, San Jose, CA (US); Sanjay Patel, San Ramon, CA (US)

(21) Appl. No.: 16/131,158

(22) Filed: Sep. 14, 2018

Related U.S. Application Data
(60) Provisional application No. 62/558,930, filed on Sep. 15, 2017.

(51) Int. Cl. G06F 9/30; G06F 9/38

(52) U.S. Cl. CPC G06F 9/30043; G06F 9/3818; G06F 9/30105; G06F 9/30101

(57) ABSTRACT

A processor is configured to implement an instruction set architecture for accessing data that includes loading data elements from a memory containing data blocks separated by block boundaries. The instruction set architecture includes a first type of data load instruction for loading an aligned data structure from the memory and a second type of data load instruction for loading an unaligned data structure from the memory. The loading includes fetching a data load instruction of the second type and loading from the memory according to the data load instruction of the second type. The resulting data structure formed of n consecutive data elements is determined from the data load instruction. The data structure loaded from memory is formed of n consecutive unaligned data elements. The processor is similarly configured to implement storing data elements from a set of registers to a memory containing data blocks separated by block boundaries.

### RELATED APPLICATIONS

This application claims the benefit of U.S. provisional patent application “Unaligned Memory Accesses” Ser. No. 62/558,930, filed Sep. 15, 2017.

The foregoing application is hereby incorporated by reference in its entirety.

### FIELD OF ART

This application relates generally to accessing data and more particularly to unaligned memory accesses.

### BACKGROUND

People regularly interact with a wide variety of electronic systems. Common electronic systems include computers, smartphones, and tablet computers, while other electronic systems now appear in many familiar items, ranging from household appliances to vehicles. These electronic systems include integrated circuits or “chips” which, depending on the system in which the chips are used, can range from simple to highly complex. The chips are designed to perform a wide variety of system functions effectively and efficiently. The chips are built using highly complex circuit designs, architectures, and system implementations. The chips are, quite simply, integral to the electronic systems. The chips are designed to implement system functions such as user interfaces, communications, processing, and networking. These system functions are applied to electronic systems used for business, entertainment, or consumer electronics purposes. The electronic systems routinely contain more than one chip. The chips implement critical system functions including computation, storage, and control. The chips support the electronic systems by computing algorithms and heuristics, handling and processing data, communicating internally and externally to the electronic system, and so on. Since the numbers of computations and other functions that must be performed are large, any improvements in chip efficiency contribute to a significant and substantial impact on overall system performance. As the amount of data to be handled increases, the approaches that are used must not only be effective, efficient, and economical, but must also scale as the amount of data increases.

Single processor architectures based on chips are well suited for some computational tasks, but are unable to achieve the high performance levels required by some high-performance systems. Multiple single processors can be used together to boost performance. Parallel processing based on general-purpose processors can attain an increased level of performance, thus parallelism is one approach for achieving increased performance. There is a wide variety of applications that demand high performance levels Such applications include networking, image and signal processing, and large simulations, to name but a few. In addition to computing power, chip and system flexibility are important for adapting to ever-changing computational needs and technical situations.

System or chip reconfigurability is another approach that can address application demands. The system or chip attribute of reconfigurability is critical to many processing applications, as reconfigurable devices are extremely efficient for specific processing tasks. In certain circumstances, the cost and performance advantages of reconfigurable devices exist because the reconfigurable or adaptable logic enables program parallelism, which allows multiple computation operations to occur simultaneously. By comparison, conventional processors are often limited by instruction bandwidth and execution rate restrictions. Note that the high-density properties of reconfigurable devices can come at the expense of the high-diversity property that is inherent in other electronic systems, including microprocessors. Microprocessors have evolved to highly-optimized configurations that provide cost/performance advantages over reconfigurable systems for tasks that require high functional diversity. However, there are many tasks for which a conventional microprocessor is not the best design choice. A system architecture that supports configurable, interconnected processing elements can be an excellent alternative for many data-intensive applications such as Big Data.

### SUMMARY

A processor-implemented method of data accessing is disclosed comprising: loading data elements from a memory containing data blocks separated by block boundaries using a processor configured to implement an instruction set architecture that includes a first type of data load instruction for loading an aligned data structure from the memory and a second type of data load instruction for loading an unaligned data structure from the memory, wherein the loading comprises: fetching a data load instruction of the second type; and loading from the memory according to the data load instruction of the second type, wherein a data structure formed of n consecutive data elements is determined from the data load instruction.

In embodiments, the data structure loaded from memory is formed of n consecutive unaligned data elements. Some embodiments further comprise loading from the memory a data structure formed of one or more consecutive aligned data elements in response to fetching a data load instruction of the first type. Other embodiments further comprise performing n+1 memory accesses to load the data structure formed of n consecutive data elements in response to fetching the data load instruction of the second type.

Additionally, a processor-implemented method of data accessing is disclosed comprising: storing data elements from a set of registers to a memory containing data blocks separated by block boundaries using a processor configured to implement an instruction set architecture that includes a first type of data store instruction for storing in the memory an aligned data structure and a second type of data store instruction for storing in the memory an unaligned data structure, wherein the storing of data elements comprises: fetching a data store instruction of the second type; and storing in the memory according to the data store instruction of the second type, wherein the data from registers of the set of registers is determined from the data store instruction to be a data structure of n consecutive data elements. In embodiments, the data structure stored in memory is formed of n consecutive unaligned data elements. Some embodiments further comprise storing in the memory data from registers of the set of registers as a data structure formed of one or more consecutive aligned data elements in response to fetching a data store instruction of the first type. Other embodiments further comprise performing n+1 memory accesses to store in the memory the data from the registers as a data structure of n consecutive data elements in response to fetching the data store instruction of the second type.

According to another aspect of the present disclosure, there is provided a processor configured to implement an instruction set architecture. This architecture includes a first type of data store instruction for storing in a memory containing data blocks separated by block boundaries an aligned data structure, and a second type of data store instruction for storing in the memory an unaligned data structure, the processor comprising a set of registers and being configured to, in response to fetching a data store instruction of the second type, store in the memory data from registers of the set of registers determined from the data store instruction as a data structure of n consecutive data elements.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 shows an example of a computer memory illustrating aligned and unaligned accesses.

FIG. 2 shows an example of a processor for implementing an instruction set architecture (ISA) including explicit unaligned data store and data load instructions, and explicit aligned data store and data load instructions.

FIG. 3 illustrates how a data structure formed of consecutive data elements stored in memory can be loaded into registers; and how data stored in registers can be stored in memory as a data structure formed of consecutive data elements.

FIG. 4 shows an example of an unaligned data load instruction included within the ISA.

FIG. 5 shows a flowchart illustrating steps involved in executing the instruction of FIG. 4 in an example implementation.

FIG. 6 shows how data to be stored in a register can be formed from a combination of data stored in a buffer from a previous processing iteration and data most recently read from memory.

FIG. 7 shows an example of an unaligned data store instruction included within the ISA.

FIG. 8 shows a flowchart illustrating steps involved in executing the instruction of FIG. 7 in an example implementation.

FIG. 9 shows how data to be stored in memory can be formed from a combination of data stored in a buffer and data read from a register.

FIG. 10 shows an integrated circuit manufacturing system.

FIG. 11 is a flow diagram for loading data elements from a memory.

FIG. 12 is a flow diagram for storing a set of registers to a memory.

FIG. 13 is a system diagram for loading and storing data.

### DETAILED DESCRIPTION

The present disclosure is directed to the provision of an instruction set architecture (ISA) that includes an explicit unaligned data store instruction and an explicit unaligned data load instruction, and a processor that implements the ISA and is configured to execute those instructions to cause multiple consecutive unaligned data elements to be stored to and loaded from the memory respectively. The instructions are explicit in that they each contain a specific pattern of bits that identifies the instructions as being of those types (i.e. as being an unaligned data store instruction and an unaligned data load instruction respectively). The pattern of bits for each instruction may comprise (e.g., be formed from) a set of opcode bits and a set of function code bits. The instruction set architecture also includes dedicated aligned data load instructions and aligned data store instructions, which can be executed to perform aligned data load and data store operations respectively.

The unaligned data load instruction, when executed by a processor, causes the processor to load into registers, from a memory, a data structure composed of n consecutive unaligned data elements of a given data type. The value of n can be specified by the instruction. The memory address to be accessed by the instruction can be specified as the sum of a value in a base address register (which may be specified in the instruction) and an offset value (which may also be specified in the instruction). The degree of misalignment of the data elements (if any) is dependent on the value in the base address register, and may be determined by the processor when the instruction is executed.

The processor may execute the unaligned data load instruction to load into registers n consecutive unaligned data elements from memory by performing only n+1 data reads from the memory. The processor may do this by storing parts of the data structure read from the memory in each data read within a buffer, and combining that data with data read from the memory in a subsequent data read. This advantageously maximizes the use of the data accessed from memory in each read.

The unaligned data store instruction, when executed by a processor, causes the processor to store, within a memory, a data structure composed of n consecutive unaligned data elements of a given data type. The data structure is read from registers, each of which may store a respective one of the n data elements forming the data structure. The value of n can be specified by the instruction. The memory address to be accessed by the instruction can be specified as the sum of a value in a base address register (which may be specified in the instruction) and an offset value (which may be specified in the instruction). The degree of misalignment of the data elements (if any) is dependent on the value in the base address register, and may be determined by the processor when the instruction is executed.

The processor may execute the unaligned data store instruction to store in memory n consecutive unaligned data elements by performing only n+1 data write operations to memory. The processor may do this by storing the data value read from a register within a buffer as part of a write operation, combining that data value with the data value read from another register in a subsequent write operation, and selecting the bits to write to memory as part of that subsequent write operation from the combined data values. This advantageously maximizes the use of the data values read from the registers. The fact that unaligned accesses will fetch extra bytes which can continue to be used for a subsequent contiguous load/store operation is a benefit to performance as fewer memory accesses need to be performed. These concepts will be explained in more detail below.

In this application, a specific example of unaligned data load and data store instructions which operate on “word” sized data elements which are 4 bytes in size will be discussed. The unaligned data store instruction may be referred to herein as an unaligned store word multiple instruction, or UASWM instruction, for brevity. The unaligned data load instruction may be referred to herein as an unaligned load word multiple instruction, or UALWM instruction, for brevity. It will be understood that the same principles would apply to instructions which operate on data elements of any “power of 2” element size, including 2 bytes, 8 bytes, 16 bytes, etc., and that equivalent instructions could be defined to operate on data elements of any of these data sizes.

Each processor implementing the proposed instruction set architecture may implement the UALWM/UASWM instructions in various ways depending on its desired application. When an UALWM/UASWM instruction is fetched by a processor for execution, the processor determines from the instruction that: (i) a specific number n of consecutive data elements is to be accessed; and (ii) the address of those data elements may be unaligned (not equal to whole multiples of the element size). Aligned memory accesses (i.e. where the address is an integer multiple of the data element size) are handled by executing separate aligned data load and aligned data store instructions (i.e. instructions separate to the UALWM/UASWM instructions). The provision of both explicit aligned and unaligned data store and data load instructions enables programs to be written that are both portable (i.e. capable of being run on different CPUs implementing the instruction set architecture) and efficient. The explicit unaligned data load and data store instructions enable a data block formed of n consecutive data elements to be loaded from or stored to memory in n+1 memory accesses, and the associated overhead for carrying out the misaligned accesses can be reduced because aligned data accesses (which are typically more common) can be executed using separate aligned data load and data store instructions.

Processor architectures have been routinely categorized by describing either the underlying hardware architecture or microarchitecture of a given processor, or by referencing the instruction set executed by the processor. The latter, the instruction set architecture (ISA), describes the types and ranges of instructions available, rather than describing how the instructions are implemented in hardware. The result is that for a given ISA, the ISA can be implemented using a wide range of techniques, where the techniques can be chosen based on preference or need for execution speed, data throughput, power dissipation, and manufacturing cost, among many other criteria. The ISA serves as an interface between code that is to be executed on the processor and the hardware that implements the processor. ISAs, and the processors or computers based on them, are partitioned broadly into categories including complex instruction set computers (CISC) and reduced instruction set computers (RISC). The ISAs define types of data that can be processed; the state or states of the processor, where the state or states include the main memory and a variety of registers; and the semantics of the ISA. The semantics of the ISA typically include modes of memory addressing and memory consistency. In addition, the ISA defines the instruction set for the processor, whether there are many instructions (complex) or fewer instructions (reduced), and the model for control signals and data that are input and output. RISC architectures have many advantages to processor design because by reducing the numbers and variations of instructions, the hardware that implements the instructions can be simplified. Further, compilers, assemblers, linkers, etc., that convert the code to instructions executable by the architecture can be simplified and tuned for performance.

In order for a processor to process data, the data must be made available to the processor or process. As discussed throughout, pointers can be used to share data between and among processors, processes, etc., by providing a reference address or pointer to the data. Rather than transferring the data to each processor or process that requires the data, a pointer can be provided. The pointers that are used for passing data references can be local pointers known only to a given, local processor or process, or they can be global pointers (GP). The global pointers can be shared among multiple processors or processes. The global pointers can be organized or grouped into a global pointer register. The registers can include general purpose registers, floating point registers, and so on. While operating systems such as Linux™ can use a global pointer for position independent code (PIC), the use of the global pointer implies that a particular register is explicitly used to support PIC handling and execution. In contrast, the presently described RISC architecture uses instructions that implicitly reference a GP source. The global pointer (GP) source provides operands manipulated by the instructions. Instructions that implicitly use GP source operands allow bits within the instructions to be used for purposes other than explicitly referencing GP registers. The result of implicit GP source operands is that the instructions can free the bits previously used to declare the global pointer, and can therefore provide longer address offsets, extended register ranges, and so on.

A further capability of the presently described architecture includes support of the rotate and exchange or ROTX instruction. This instruction can support a variety of data operations such as bit reversal, bit swap, byte reversal, byte swap, shifting, striping, and so on, all within one instruction. The use of the ROTX instruction provides a computationally inexpensive technique for implementing multiple instructions within one instruction. The rotate and exchange instruction can overlay a barrel shifter or other shifter commonly available in the presently described architecture. Separately implementing these various rotate, exchange, or shift instructions would increase central processing unit (CPU) complexity because each instruction impact one or more aspects of the CPU design. By merging the various instructions into the ROTX instruction, CPU hardware that implemented the separate instructions can be combined to achieve a less complex processor.

Processors commonly include a “mode” designator to indicate that the operating mode of a processor is based on a number of bytes, words, and so on. For some processor architecture techniques, a mode can include a 16-bit operation, a 32-bit operation, a 64-bit operation, and so on. One or more bits within an instruction can be used to indicate the mode in which a particular instruction is to be executed. In contrast, if the processor is designed to operate without mode bits within each instruction, then the mode bits within each instruction can be repurposed. The repurposed bits within the instruction can be used to implement the longer address offsets or extended register ranges described elsewhere. When an operation “mode” is still needed for a particular operation, then instructions that are code-density oriented can be added. Specific instructions can be implemented for 16-bit, 32-bit, 64-bit, etc., operations when needed, rather than implementing every instruction to include bits to define a mode, whether the mode is relevant to the instruction or not.

Storage used by processors can be organized and addressed using a variety of techniques. Typically, the storage or memory is organized into groups of bytes, words, or some other convenient size. To make storage or memory access more efficient, the access acquires as much data as is reasonable with each access, thus reducing the numbers of accesses. Access to the memory is often most efficient in terms of computation or data transfer when the access is oriented or “aligned” to boundaries such as word boundaries. However, data to be processed does not always conveniently align to boundaries. For example, the operations to be performed by a processor may be byte oriented, the amount of data in memory may align to a byte boundary but not a word boundary, and so on. Accessing specific content such as a byte can, under certain conditions and depending on the implementation of the processor, require multiple read operations. To improve computational efficiency, unaligned memory access can be required. The unaligned memory access may be needed for computational if not access efficiency. A given instruction set architecture can support explicit unaligned storage or memory accesses. The general forms of the load and store instructions for the ISA can include unaligned load instructions and unaligned store instructions. The unaligned load instructions and the unaligned store instructions support a balance or tradeoff between increased density of the code that is executed by a processor and reduced processor complexity. The unaligned load instructions and the unaligned store instructions can be implemented in addition to the standard load instructions and store instructions, where the latter instructions align to boundaries such as word boundaries. When an unaligned load or store is performed, the “extra” data such as bytes that can be accessed can be held temporally for potential use by a subsequent read or store instruction (e.g. data locality).

For various reasons, execution of code can be stopped at a point in time and restarted at a later point in time, after a duration of time, and so on. The stopping and restarting of code execution can result from an exception occurring, receiving a control signal such as a fire signal or done signal, detecting an interrupt signal, and so on. In order to efficiently handle save and restore operations, an instruction set architecture can include instructions and hardware specifically tuned for the save and the store operations. A save instruction can save registers, where the registers can be stored in a stack. The saved registers can include source registers. A stack pointer can be adjusted to account for the stored registers. The saving can also include storing a local stack frame, where a stack frame can include a collection of data (or registers) on a stack that is associated with an instruction, a subprogram call, a function call, etc., that caused the save operation. The restore operation can reverse the save technique. The registers that were saved by the save operation can be restored. The restored registers can include destination registers. When the registers have been restored, the restore operation can cause a jump to a return address. Code execution can continue, beginning with the return address.

An example implementation will now be described in which parts of the data structure read from/written to memory in each data access are stored within a buffer, with that data being combined with data read from/written to memory in a subsequent data access. Other implementations, such as those intended for applications where it is appropriate to have lower performance in exchange for lower power and area cost, may implement the UALWM/UASWM instructions using simpler operations and a greater number of processing iterations (i.e. greater than n+1). Other implementations may for example take a multiple of n iterations to complete the data load/store operation. However, each implementation may be such that the UALWM/UASWM instructions can be executed by the processor to complete the load/store operation without requiring intervention from an operating system. This enables the UALWM/UASWM instructions to be implemented without incurring a disproportionately high cost in the overall execution time of a program including the instructions.

A CPU instruction set architecture (ISA) may be considered as the definition of all the instructions to be understood by a processor, and how those instructions should make the processor behave. One challenge in ISA design is that CPUs with relatively high power and area budgets will typically benefit from implementing more complex instructions capable of performing more complex tasks in a smaller number of processing cycles, whereas CPUs with lower power and/or area budgets may find these more complex instructions difficult to implement within the power and/or area budget.

One typical requirement of an instruction set architecture is to provide a way to load or store data from memory. A load instruction reads some number of bytes of data from a specified address in memory to one or more registers. A store instruction writes some number of bytes of data from one or more registers to a specified address in memory.

Depending on the implementation, the data may pass through a number of stages while being transferred to/from external memory. For instance, the address being accessed may be translated by a Translation Lookaside Buffer (TLB) and it may be stored in one or more levels of a data cache. Some of the stages involved in the transfer of data from registers to memory will be subject to a specific memory block size. Accesses whose address range is entirely within one memory block can be completed with one operation, but accesses whose address range spans two or more memory blocks will require two or more operations to complete. For instance, a memory access which spans two TLB pages would require two TLB lookups. Likewise, a memory access which spans two cache lines would require two cache accesses. Memory accesses for which the address range is known to reside entirely within a single block for each level of the memory hierarchy will typically require less hardware resources, and may execute more quickly, than accesses where the address range crosses two or more blocks.

Typically, a computer program will attempt to prevent memory accesses from crossing a block boundary in the memory hierarchy by keeping data addresses aligned. However, when data contains elements of different sizes which are tightly packed into a structure or stream in order to save memory usage, it is not always possible to keep data elements aligned.

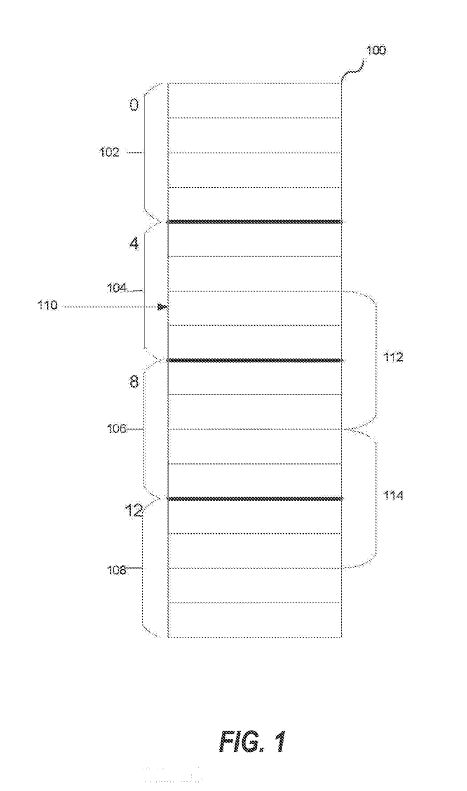

FIG. 1 shows an example computer memory 100 that comprises four data blocks 102, 104, 106, and 108. In this example, each block is 4 bytes in size. Data alignment occurs when data to be accessed is at a memory address equal to some integer multiple of the size of the data elements forming the data. The size of the data elements (i.e. the bit width) depends on the data type of the data elements (e.g. whether the data elements are bytes, halves, words, doubles etc.). For power of two data element sizes, data misalignment occurs when data to be accessed is located at a memory address that is not an integer multiple of the data element size.

A data structure formed of data elements 112 and 114 is also shown. In the example shown here, each data element is 4 bytes. Thus, in this example, data elements 112 and 114 would be considered aligned if they were located at a memory address that is a multiple of 4 (e.g. address 0, address 4, address 8, or address 12). In the example shown in FIG. 1, data element 112 is not aligned because it is located at memory address 6 (indicated at 110), which is not an integer multiple of the data element size. Data element 114 is not aligned for similar reasons.

Accessing misaligned elements introduces the possibility that the access will cross the boundary between two blocks at some level of the memory hierarchy. This is true independent of the size of the data elements or the size of the blocks in the memory hierarchy. Further, in typical pipelined CPU designs, accounting for the possibility that an access could cross the boundary between two blocks in the memory hierarchy introduces the same computational overhead, both in cases where the access actually does cross the boundary between two blocks, and in cases where that the access fits entirely within one block. These possibilities exist because the CPU may schedule accesses to each relevant memory block before it has read the target address of the memory access to know whether the target data does reside in one or more than one block.

The problem of accessing misaligned data can be magnified when multiple consecutive unaligned data elements of a given data type are accessed. For example, in order to access the two data elements 112 and 114 in FIG. 1 consecutively, a conventional program might issue two memory access instructions, one for element 112, and one for element 114. The CPU may split the operation of each of these instructions into two parts to ensure that no single memory access crosses the boundary between two blocks in the memory hierarchy. The two instructions may therefore require four memory accesses: a first memory access to memory block 104 to access the first two bytes of element 112; a second memory access to memory block 106 to access the second two bytes of element 112; a third memory access to memory block 106 to access the first two bytes of element 114; and a fourth memory access to memory block 108 to access the second two bytes of element 114.

Accessing multiple consecutive unaligned data structures can therefore result in large amounts of memory accesses, which can lead to undesired delays in processing time.

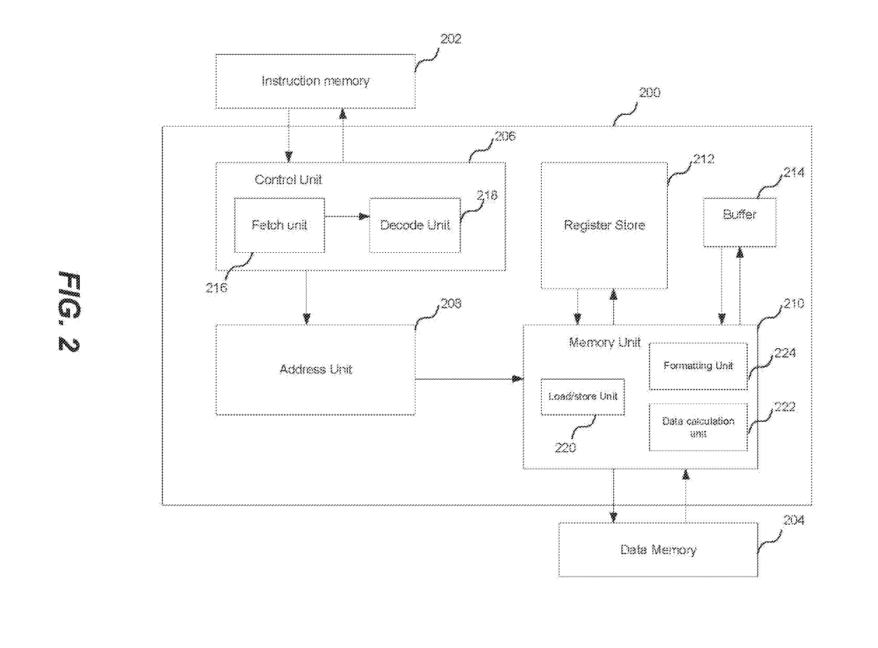

FIG. 2 shows a processor 200 in which the methods described herein may be implemented. The processor is coupled to an instruction memory 202 and a data memory 204. The instruction memory stores instructions to be executed by the processor 200. The data memory 204 is shown as being external to the processor 200, but it will be appreciated that the memory 204 could be included within the processor 200 and/or included on the same chip as the processor 200. Likewise, though the instruction memory is shown as being external to the processor 200, it could be included within the processor 200 and/or included on the same chip as the processor. The instruction memory 202 and data memory 204 could be separate memories, or could form part of a single memory. The memory 204 could be a cache or some other type of memory.

The processor 200 comprises a control unit 206; an address unit 208; a memory unit 210; a register store 212; and a buffer 214. The control unit comprises a fetch unit 216 and a decode unit 218.

The control unit fetches and decodes instructions from the instruction memory 202. Instruction fetches are performed by the fetch unit 216, and instruction decodes are performed by the decode unit 218. The control unit may fetch instructions from the instruction memory in accordance with a program order as indicated by a program counter. Once an instruction has been fetched, the decode unit operates to interpret the instruction. In response to the control unit decoding a load/store instruction, the address unit 208 operates to calculate addresses in the memory 204 for use in the load/store operations. The instruction can also be dispatched from the control unit (e.g. from the decode unit) to the memory unit 210. The instructions may be dispatched to a load/store unit 220 implemented within the memory unit 210 for implementing the load/store operations as specified by the instruction.

Register store 212 comprises a number of registers (e.g. 32 registers). In the examples described herein, the registers store data loaded from the memory 204 as part of the execution of a load instruction; and store data to be stored in memory 204 as part of the execution of a store instruction.

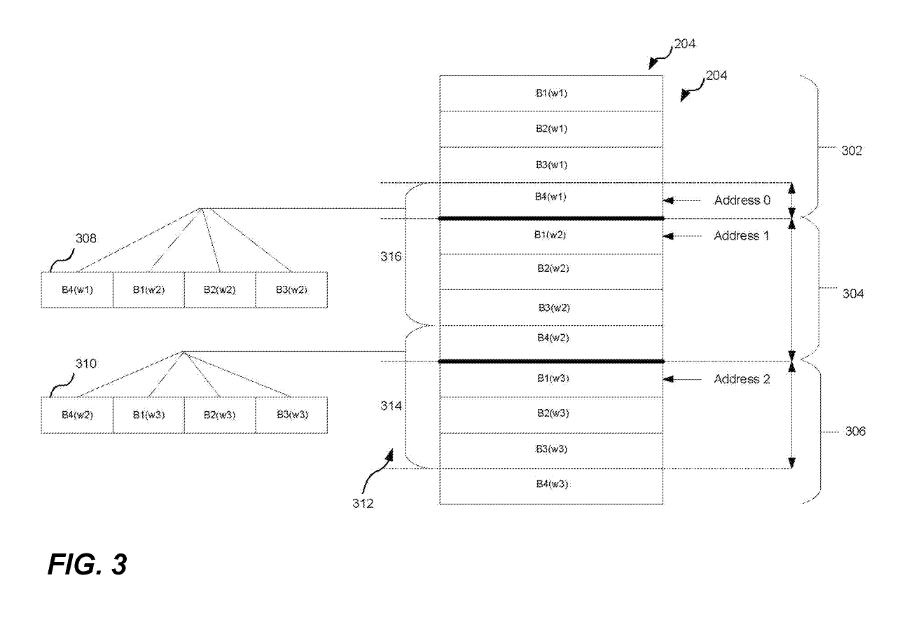

The operation of the processor 200 when executing an UALWM instruction and UASWM instruction will now be described. For the purposes of clarity, this explanation will be made with reference to the example data structure, memory, and register arrangement shown in FIG. 3. FIG. 3 shows the example arrangement of a data structure in memory 204, where the memory is shown structured into three blocks 302, 304 and 306 separated by block boundaries. In this example, the memory contains three blocks each comprising m bytes. In this example, m=4, though it will be readily appreciated that the memory blocks might comprise other numbers of bytes. In addition, though only three blocks are shown in FIG. 3, in general the memory may be structured into a plurality of data blocks separated by block boundaries.

The bytes comprising the first block 302 are denoted B1-B4(w1); the bytes comprising the second block 304 are denoted B1-B4(w2); and the bytes comprising the third block 306 are denoted B1-B4(w3). Also shown are two registers 308 and 310 from the register store 212. Each register is shown as being capable of storing an m-byte data element. It will be appreciated that each register may be capable of storing multiple data elements.

The unaligned data structure to be loaded from/stored to memory 204 is denoted generally at 312, and is composed from n consecutive data elements denoted 314 and 316. In this example and for ease of illustration, n=2. Furthermore, in this example, each data element is 4 bytes, but in general the data element size (in bits) could be equal to a power of 2.

It can be seen that the data structure 312 is not aligned, that is that the addresses of the elements 314, 316 in the data structure are not whole multiples of the element size, and hence that each element in the data structure spans two blocks within the memory 204. The amount by which the data structure is misaligned with the block boundaries of the memory may be referred to herein as a misalignment factor. The misalignment factor may be expressed as an integer value. It could be expressed as a modulo value of the memory address of the data element forming the data structure and the number of bytes in the data element (i.e. m). In this example, the misalignment factor is 3.

The memory in this example contains 3 blocks comprising 4 bytes each, and each 4 byte element in the data structure spans two of those memory blocks. In practice, the effective size of memory blocks in an implementation depends on details of the memory hierarchy (including for instance the TLB page size and the cache line size), and might be different from, for instance bigger than, the size of elements in the data structure. However, the principles illustrated in this example will continue to apply in more general cases, because the elements in a data structure whose address is not a whole multiple of its element size may potentially span two (or more) memory blocks, even when the memory blocks are larger than the data elements. A typical CPU will need to account for the possibility that a data element could span more than one memory block even if the data element does in fact fit within a single block, because it may need to schedule memory and register accesses before knowing whether the access is contained in a single block.

In summary, execution of the UALWM instruction causes the unaligned data structure 312 to be loaded from memory 204 into the registers 308 and 310 so that each consecutive data element of the data structure is loaded into a respective register. In the example implementation described herein, execution of the UALWM instruction enables the data structure 312 to be loaded into registers 308 and 310 from three memory reads of memory 204 (i.e., from n+1 memory reads in general). Execution of the corresponding UASWM instruction causes the data elements stored in registers 308 and 310 to be stored in memory 204 as the unaligned data structure 312. That is, n data elements read from registers are stored in the memory 204 as an unaligned data structure composed of the n elements arranged sequentially. In the example implementation, execution of the UASWM instruction enables the two data elements from the registers to be stored in the memory 204 from three memory writes (i.e., from n+1 memory writes in general).

It will readily be appreciated that there are other ways to implement the UALWM and UASWM instructions; the choice of implementation may depend on the specific details of the memory and caches of the processor, and the context in which the processor will be used, for example the desired trade-off between performance, area and power for the intended use of the processor. The example implementation which is described in more detail below illustrates some of the advantages of the provision of the UALWM and UASWM instructions within the instruction set architecture, which can be used by other implementations.

Data Loading

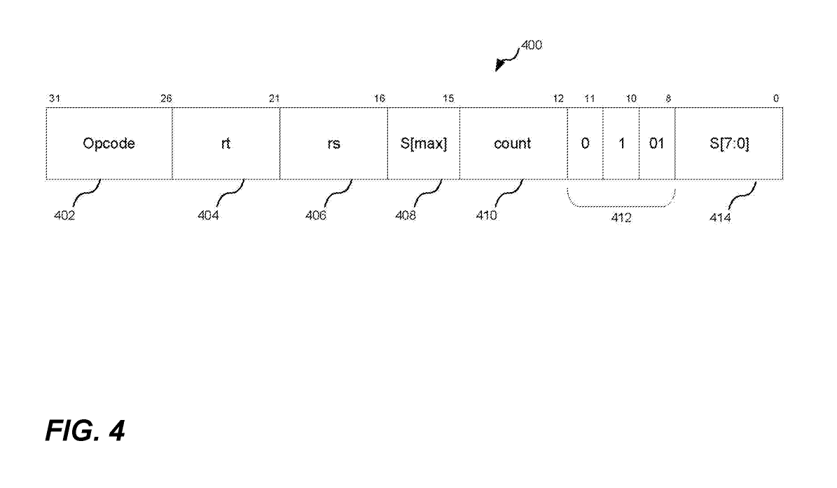

An example of the UALWM instruction is illustrated in FIG. 4 at 400. The instruction comprises a number of fields: an opcode field 402; a destination address field 404 indicating an initial register to write to; a source address field 406 indicating a base address in memory 204 to access; offset fields 408 and 414 indicating the displacement to be added to the value in the register rs to compute the memory address to be accessed; an encoded count field 410 indicating the value of n (with the value 0 in the field indicating that n equals a specified maximum value, for example n=8 for a 3-bit count field); and further fields denoted generally at 412 that specify a function code that can be used in combination with the opcode 402 to uniquely identify the instruction as an UALWM instruction.

The integer values along the top edge of the instruction are bit numbers. Instruction 400 is therefore a 32-bit instruction. However, it will be appreciated that the instruction need not be 32 bits but could contain a different number of bits. For example, the instruction could be a 16-bit instruction, or a 64-bit instruction.

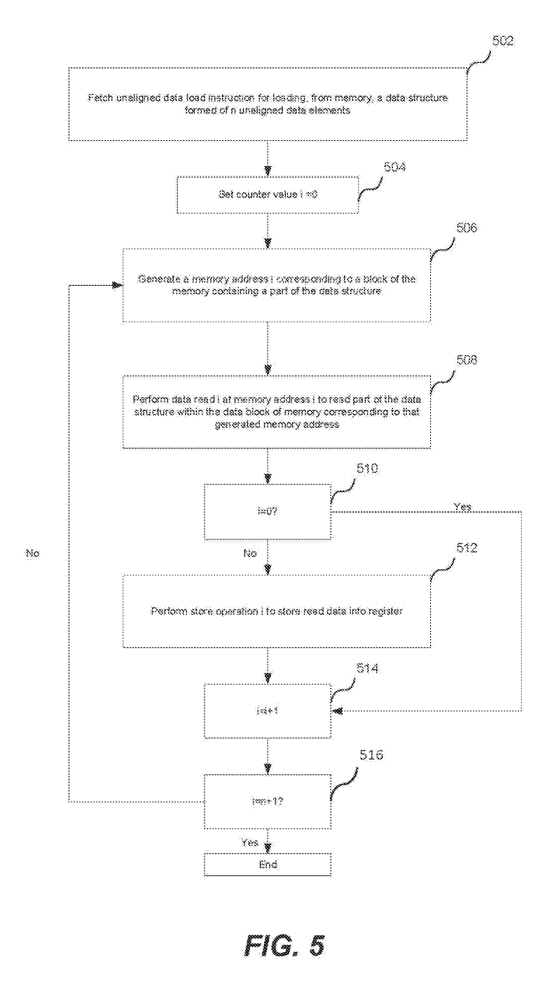

FIG. 5 shows a series of steps that may be performed by the processor 200 when executing an UALWM instruction (e.g. instruction 400).

At step 502, the fetch unit 216 fetches an UALWM instruction from instruction memory 202. The instruction is then decoded by the decode unit, which identifies the instruction as being an UALWM instruction from its opcode bits and potentially its function code.

The decode unit 218 further determines from the count field 410 the number n of consecutive misaligned data elements to be loaded from the memory 204 (i.e. the number n of consecutive misaligned data elements forming the data structure).

At step 504, a counter value i is initialized (in this example, the value i is initialized to 0). The counter value is used to count the processing iterations performed by the processor in executing the UALWM instruction. The counter value may be maintained by a hardware counter included within the control unit (not shown in FIG. 2).

At step 506, the address unit 208 calculates a memory address i of the memory 204. The address is chosen so that the memory access to be carried out in each iteration i does not cross the boundary between any two blocks in the memory hierarchy 204. The initial address (denoted address 0) calculated by the address unit is the address of the initial data element of the data structure 312 (in this example, data element 316). The initial address resides within the data first memory block 302, and to ensure that the first memory access does not cross any memory block boundaries, the number of bytes read in the first access will be limited to the number of bytes in the first element which are known to reside within the first memory block 302.

The address unit 208 calculates the addresses from a base address value of memory 204 stored within a base address register indicated by the instruction 400, and an offset. The base address register is indicated in the field 406. The address offset may be formed of two components: a fixed address offset and an incremental address offset. The incremental offset may be calculated by the address unit from the counter value and the element size (e.g. the value m). When calculating the initial address, the value of the incremental offset is equal to zero (because the counter value is equal to zero). Thus, the memory address unit calculates the initial address from only the base address and fixed address offset indicated by the instruction 400.

At step 508, the load/store unit 320 of the memory unit 210 performs a data read i at the calculated memory address i to read part of the data structure within the data block of memory 204 corresponding to the calculated memory address i.

That is, the load/store unit performs a data read operation to access the memory block containing the calculated address i (which in the first iteration is block 302), and to read from the address within that block the part of the data structure located in that block (in this example, that part of the data structure is B4(w1)). When i=0, the data read operation is denoted data read operation 0.

The memory unit 210 may calculate the amount of data to read from the memory block corresponding to the calculated memory address i. The amount of data to be read may be calculated by the data calculation unit 222.

The data calculation unit 222 may be configured to calculate the amount of data to read when reading the calculated memory address corresponding to the initial part of the data structure 312 (i.e. when i=0) from the difference between the width of the data elements m in memory and the misalignment between the data structure and the memory block boundaries. In the present example, the width of the data elements in memory is 4 bytes, and the misalignment factor between the data structure and the memory block boundaries is 3. The data calculation unit 222 therefore calculates the number of bytes to read from the memory block 302 corresponding to memory address 318 as 1 byte.

The load/store unit therefore reads 1 byte of data from calculated memory address 318 (i.e. it reads B4(w1)).

The memory unit 210 then stores the data read from that data read operation (B4(w1)) into buffer 214. This data will be used for a subsequent load operation to load data into a register.

At step 510, it is determined whether the count value i=0 (i.e. it is determined whether the first data read instruction has just been performed). This may be performed by the control unit 206, or memory unit 210. If so, the process proceeds to step 514, and the value of the counter is incremented.

At step 516, it is determined whether the counter has exceeded its bounding value of ‘n’. If so, the process ends. In the current example, i is incremented to ‘1’, which is below the bounding value of n=2. The process therefore returns to step 506.

The address unit then proceeds to calculate the second memory address, denoted address 1.

Memory address 1 corresponds to the memory block 304 containing a portion of the data structure 312.

The address unit 208 calculates memory address 1 from: 1) the base address in the register indicated by the instruction 400; 2) the fixed address offset indicated by instruction 400; 3) an incremental address offset calculated in dependence on the data element width m and counter value; and 4) the misalignment between the data structure 312 and the block boundaries of the memory 204.

The incremental address offset increments the previously calculated memory address (address 0) by the value m. The misalignment is then subtracted from the incremented address to calculate address 1. The purpose of subtracting the misalignment from the incremented address value is to align calculated address 1 with the block boundary of the memory. Memory address 1 is therefore aligned with the boundary of the memory block 304 containing an intermediate portion of the data structure 312.

At step 508, the load/store unit 220 performs data read 1 to read the part of the data structure within the memory block 304 corresponding to memory address 1.

The amount of data to be read from address 1 is calculated by the data calculation unit 222.

The data calculation unit 222 is configured to calculate the amount of data to read from the calculated memory address corresponding to a memory block containing an intermediate portion of the data structure 312 as being equal to memory block width. In other words, the data/store unit operates to read a whole memory block width worth of bytes from the data structure 312. Thus, in this example, the load/store unit reads the four bytes B1(w2)-B4(w2) of memory block 304.

At step 510 it is determined that the current value of i does not equal 0, and so the process proceeds to step 512.

At step 512, the load/store unit 220 performs register store operation i (i.e. register store operation 1) to store data read from the memory 204 into a register of the register store 212. The data stored into the register is a combination of data most recently read from the memory 204 and data from the buffer 214.

The memory unit determines the register into which the data is to be written to from: a base register number indicated in the instruction 400 (by the field 404); and ii) the incremental counter value. The identified register in this example is register 308.

To perform the register store operation, the memory unit 210 uses the data most recently read from the memory 204 from data read operation 1, and the data stored in buffer 214 from the previous data read operation 0. The data stored in the buffer may be concatenated with the data read from the memory to form an intermediate data string. A portion of the data from this intermediate string can then be written to the register 308. The data to write to the register may be determined by formatting unit 224 within the memory unit 210.

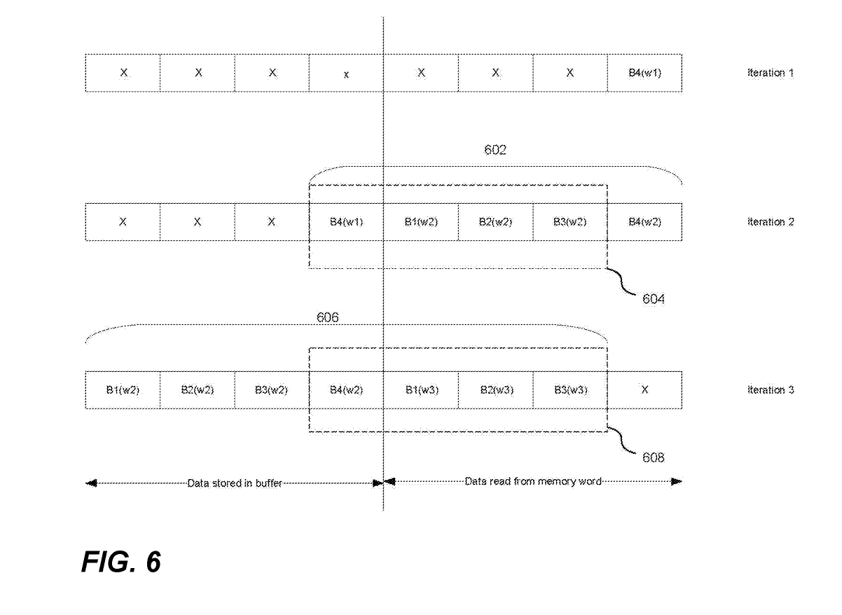

The above processing as performed by the formatting unit is illustrated in FIG. 6, which shows the data stored in the buffer 214 and the data read from memory for each processing iteration. During the first processing iteration (i.e. when i=0), data B4(w1) is read from memory block 302, and subsequently stored in buffer 214 for use in a subsequent register store operation. During the second processing iteration (i.e. when i=1), data B4(w1) is located in the buffer 214 and data block B1(w2)-B4(w2) is read from the memory block 304. The formatting unit 224 combines this data to generate the intermediate data string shown at 602. The intermediate data string is formed from the concatenation of the data in the buffer (which is the data read from memory 204 from the previous data read operation) with the data read from memory in the current data read operation.

The data to be written into register 308 is shown at 604. To determine this data, the formatting unit may perform a shift operation to right-shift the intermediate data string 602. The amount of right-shift may be calculated by the formatting unit from the difference between the data element width m and the misalignment factor. In this example, the formatting unit right-shifts the intermediate data string by a number of bytes equal to the difference between m and the misalignment factor. Thus, the formatting unit right-shifts the intermediate data string by 1 byte, which shifts out byte B4(w2). The m least significant bytes of the shifted intermediate data string are then determined by the formatting unit 224 to be the data portion to be loaded into the register 308.

In other words, the register store operation 1 performed by the load/store unit causes the first data element 316 of the n consecutive unaligned data elements forming the data structure 312 to be written into a register.

Following the writing of data 604 into the register, the buffer 214 is updated to store the data read from the memory in data read operation 1 (i.e. B1(w2)-B4(w2)). The previous data in the buffer may be flushed prior to the buffer being updated.

At step 514 the counter is incremented to i=2, and at step 516 it is determined that the counter value i=2 has not exceeded the bounding value n=2.

The process therefore returns again to step 506.

At step 506 the address unit 208 calculates a third memory address, denoted address 2.

Memory address 2 corresponds to the memory block 306 containing a portion of the data structure 312.

The address unit 208 calculates memory address 2 from: 1) the base address indicated by the instruction 400; 2) the fixed address offset indicated by instruction 400; 3) an incremental address offset calculated in dependence on the element width m and counter value; and 4) the misalignment between the data structure 312 and the block boundaries of the memory 204.

The incremental address offset increments the initially calculated memory address (address 0) by the value 2m. The misalignment is then subtracted from the incremented address to calculate address 2. It can be seen with reference to FIG. 3 that memory address 2 is aligned with the boundary of the memory block 306 containing the end, or remaining portion of the data structure 312.

At step 508, the load/store unit 220 performs data read operation 2 to read the part of the data structure within the memory block 306 corresponding to memory address 2.

The amount of data to be read from address 2 is calculated by the data calculation unit 222.

The data calculation unit 222 is configured to calculate the amount of data to read from the calculated memory address residing in a memory block containing the end, or remaining portion of the data structure 312 from the misalignment factor. The data calculation unit 222 knows it is calculating the final memory address (i.e. the memory address within the memory block containing the end portion of the data structure) from the counter value; in this example when the counter value=n. In this example, the data calculation unit calculates the number of bytes to read from the memory address within the memory block containing the end portion of the data structure as being equal to the misalignment factor. The data calculation unit therefore calculates the number of bytes to read from address 2 within memory block 306 as 3 bytes.

The load/store unit therefore performs data read operation 2 to read 3 bytes of data from calculated memory address 2 (i.e. it reads bytes B1(w3)-B3(w3)).

At step 510 it is determined that i does not equal 0 and so the process proceeds to step 512.

At step 512, the load/store unit 220 performs a register store operation i (i.e. register store operation 2) to write data read from the memory 204 into another register of the register store 212.

The memory unit performs register store operation 2 using data read from the memory 204 from data read operation 2, and the data stored in the buffer 214 from the previous data read operation 1. That is, the register store operation 2 stores combined data from the most recent data read from memory 204 and data from the buffer into a register of the register store. This is shown in FIG. 6, where it can be seen that during the third processing iteration (i.e. when i=2), data B1(w2)-B4(w2) is stored in the buffer from the previous data read operation, and data B1(w3)-B3(w3) is read from the memory block 306 from the current data read operation. The formatting unit combines this data to generate the intermediate data string shown at 606. The intermediate data string 606 is formed from the concatenation of the data in the buffer with the data read from memory in the current data read operation.

The data to be loaded into register 310 is shown at 608. To determine this data, the formatting unit performs a shift operation to right-shift the intermediate data string 606 by a number of bytes equal to the difference between m and the misalignment factor. Thus, the formatting unit right-shifts the intermediate data string by 1 byte. The m least significant bytes of the shifted intermediate data string are then determined by the formatting unit 224 to be the data portion to be written into the register 310.

In other words, the register store operation 2 performed by the load/store unit causes the second data element 314 of the n consecutive unaligned data elements forming the data structure 312 to be loaded into a register.

In summary, the processor 200 performs n+1 processing iterations in response to decoding an unaligned data load instruction indicating that a data structure formed of n consecutive unaligned data elements are to be loaded from memory 204. The address unit 208 generates a memory address for the memory 204 during each processing iteration (i.e. it generates a set of n+1 memory addresses). Each generated address is within a respective memory block of the memory 204 containing a portion of the data structure. The set of n+1 addresses are generated so that only one of the addresses is unaligned with the block boundaries of the memory. That address is the address residing in the memory block containing the initial part of the unaligned data structure (i.e. the address generating during the first processing iteration), and is generated from the base memory address and fixed offset indicated by the instruction.

The remaining generated addresses (i.e. addresses 2-n+1) are aligned with the block boundaries of the memory 204, and are generated from: 1) the base memory address indicated by the instruction; 2) the fixed memory offset indicated by the instruction; 3) an incremental memory offset calculated using the element width m and counter value; and 4) the misalignment factor.

The memory unit 210 performs a data read operation from memory 204 during each processing iteration (i.e. a set of n+1 data read operations are performed). Each data read operation is performed at a respective generated address. The memory unit calculates the amount of data to be read at each generated address. For the generated memory address within the memory block containing the beginning of the data structure (memory block 302 in the above example), the amount of data is calculated in dependence on the data element width m and the misalignment factor. For the generated memory address within the memory block containing the end of the data structure (memory block 306 in the above example), the amount of data is calculated from the misalignment factor. For each of the remaining generated addresses (i.e. the generated addresses within memory blocks containing intermediate portions of the data structure —memory block 304 in the above example), the amount of data read is equal to the memory block width.

For each processing iteration, data read from the memory 204 as part of the data read operation is stored in a buffer for use in a subsequent processing iteration. Each processing iteration subsequent to the initial processing iteration involves a data write operation to a respective register. The data write operation for a given processing iteration uses the data read from the memory 204 from the data read operation performed during that processing iteration, and the data written to the buffer from the data read operation of the previous processing iteration. In particular, each data write operation includes the steps of forming an intermediate data string from the data in the buffer and the data read from the memory in the current data read operation. A data value selected from the intermediate binary string is then written to a register.

Storing the data read from each memory access in a buffer for use in a subsequent processing iteration conveniently enables a data structure formed of n consecutive unaligned data elements to be loaded from memory into n registers from only n+1 data accesses to the memory. This is an improvement over some conventional approaches, which may require up to 2n data accesses in order to load n consecutive unaligned data elements.

Moreover, a computer architecture which contains both an unaligned data load instruction and an aligned data load instruction can benefit from improved flexibility in implementing the unaligned data load instruction in hardware. The unaligned data load instruction can be invoked by software only in the cases where the program cannot guarantee that the memory address is aligned. Typically, this may occur relatively infrequently. Knowing that the unaligned data load instruction may be called relatively infrequently, hardware can choose to implement the instruction in a way that requires extra cycles (e.g., processing iterations) to execute relative to the aligned case, knowing that these extra cycles do not need to be expended frequently (in particular, they do not need to be expended for the (typically) more common case where the access is aligned and known to the program being executed to be aligned). Allowing the explicitly unaligned case to consume extra cycles may allow implementations to use less area in silicon and consume less power than if the hardware were required to consider the possibility that accesses might be unaligned, while still taking the least possible cycles to execute the cases that turn out to be aligned. For instance, a pipelined CPU might always schedule the execution of an unaligned data load instruction to take n+1 iterations, even though aligned accesses could in principle be completed in n iterations. This might be beneficial because the pipeline has not read the register containing the base address of the access (to find out whether the access is aligned) in time to use that information to decide whether n or n+1 iterations will be required.

Data Storing

The process of executing a corresponding UASWM instruction to cause the data elements stored in registers 308 and 310 to be stored in memory 204 as the unaligned data structure 312 will now be described.

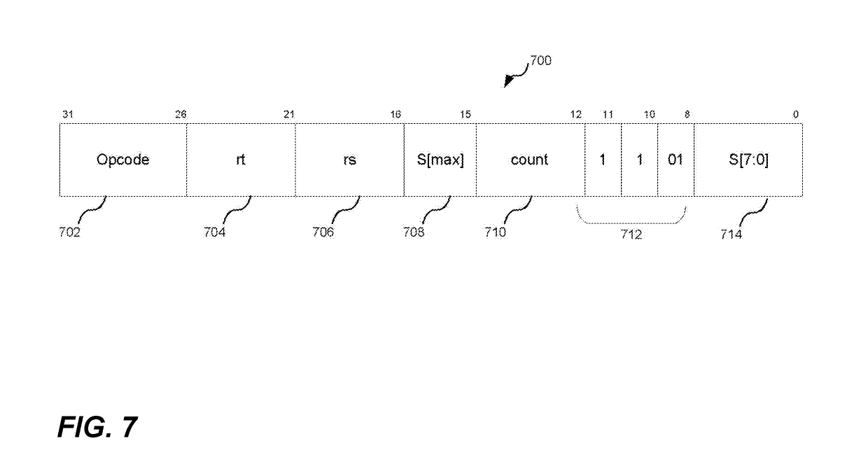

An example of the UASWM instruction is illustrated in FIG. 7 at 700. The instruction comprises a number of fields: an opcode field 702; a source address field 704 indicating an initial register to read from; a destination address field 706 indicating a register containing a base address in memory 204 to access; offset fields 708 and 714 indicating the displacement to be added to the value in register rs to compute the address to be accessed; an encoded count field 710 indicating the value of n (with the value 0 in the field indicating that n is equal to a specified maximum value (e.g. n=8 in the case that field 710 is a 3-bit field), and further fields denoted generally at 712 that specify a function code that can be used in combination with the opcode 702 to uniquely identify the instruction as an UASWM instruction.

The integer values along the top edge of the instruction are bit numbers. Instruction 700 is therefore a 32-bit instruction. However, it will be appreciated that the instruction need not be 32 bits but could contain a different number of bits. For example, the instruction could be a 16-bit instruction, or a 64-bit instruction.

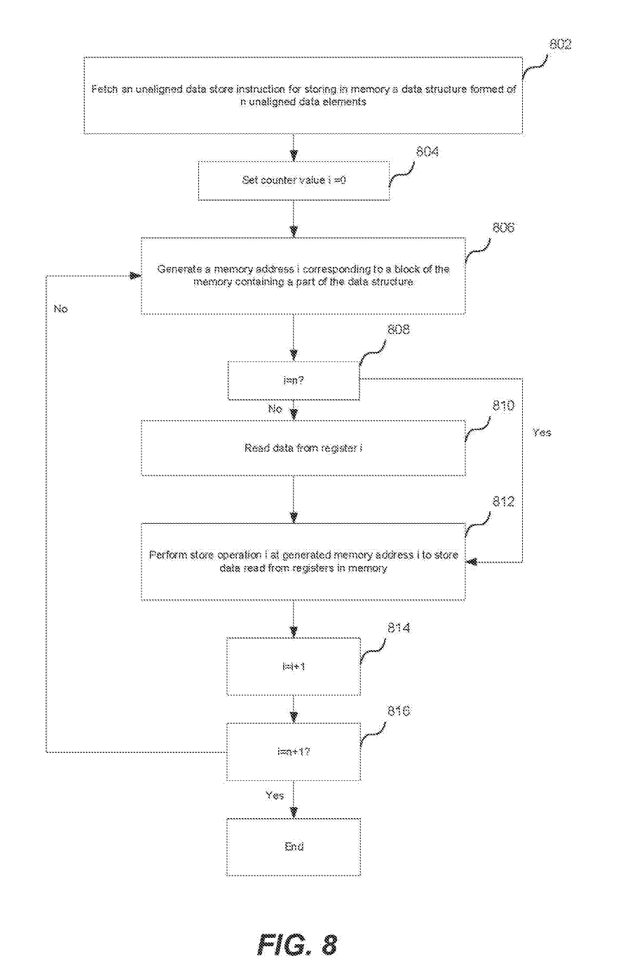

FIG. 8 shows a series of steps that may be performed by the processor 200 when executing an UASWM instruction (e.g. instruction 700).

At step 802, the fetch unit 216 fetches an UASWM instruction from instruction memory 202. The instruction is then decoded by the decode unit 218, which identifies the instruction as being an UASWM instruction from its opcode bits and potentially its function code.

The decode unit 218 further determines from the count field 710 the number n of consecutive misaligned data elements to be stored in the memory 204 (i.e. the number n of consecutive misaligned data elements forming the data structure to be stored).

At step 804, a counter value i is initialized (in this example, the value i is initialized to 0). The counter value is used to count the processing iterations performed by the processor in executing the UASWM instruction. The counter value may be maintained by a hardware counter included within the control unit (not shown in FIG. 2).

At step 806, the address unit 208 calculates a memory address i of the memory 204. The address unit 208 operates to calculate the addresses in the same way as that described above with reference to FIG. 5, and so a description of that process will not be repeated here.

The initial address calculated by the address unit 208 will therefore be address 0 (shown in FIG. 3).

At step 808, it is determined whether the count value i=n. This determination may be made by the control unit 206, or memory unit 210.

Continuing the current example, i=0 (and n=2), and so the process proceeds to step 810.

At step 810, the memory unit 210 performs a data read operation i to read a data value from a register.

The register number from which to read the data value is calculated from: i) the base register number indicated by the UASWM instruction (e.g. in field 704); and ii) an incremental counter value. In this example, during the first processing iteration the counter value=0 and so the register number is determined only from the base register number indicated in the instruction. The register number may be calculated by the address unit 208, or by the memory unit 210.

Continuing the current example, the first register is identified as register 308 shown in FIG. 3.

At step 812, the load/store unit 220 of the memory unit 210 performs a data store operation i (i.e. data store operation 0 at this iteration) at generated address i (i.e. generated address 0 at this iteration) to store data read from the registers into the memory 204.

That is, the load/store unit performs a data store operation to access the memory block containing the generated memory address i (which in the first iteration is block 302), and write data from the registers to that generated memory address.

To perform the data store operation, the memory unit uses the data value most recently loaded from the registers from data read operation 0, and data stored in buffer 214 from a previous data read operation. Since this is the first processing iteration, the buffer has no prior values stored. The data stored in the buffer may be concatenated with the data read from the register to form an intermediate data string. A portion of the data from this intermediate string can then be written to the memory address 0. The data to write to the memory address may be determined by the formatting unit 224 and the data calculation unit 222.

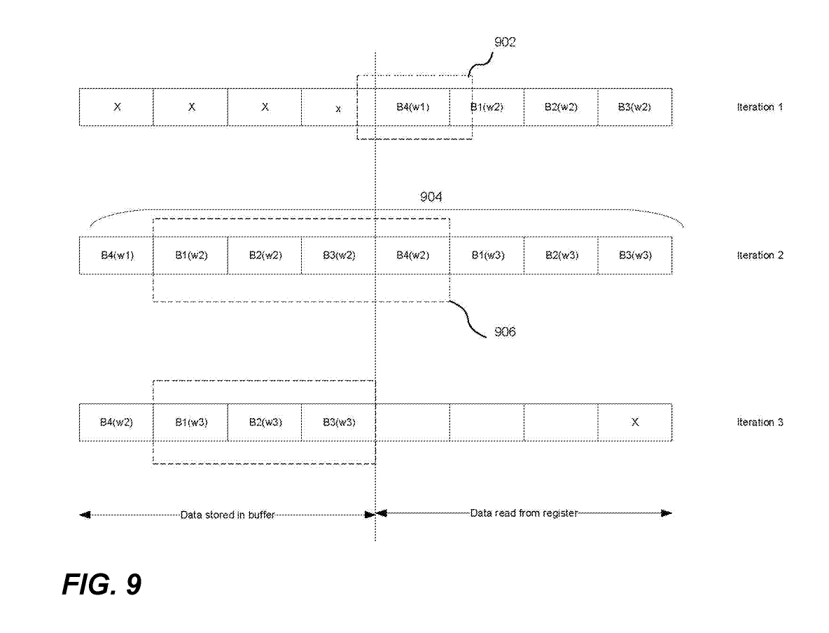

The processing performed by the formatting unit is illustrated in FIG. 9, which shows the data stored in the buffer 214 and the data read from a register for each processing iteration. During the first processing iteration (i.e. when i=0), the data value B4(w1)B1(w2)B2(w2)B3(w2) is read from register 308. No data is stored in the buffer. The intermediate data string is therefore the data value B4(w1)B1(w2)B2(w2)B3(w2).

The data to be stored at address ‘0’ is shown at 902. To identify this data from the intermediate string, the formatting unit first performs a shift operation to right-shift the intermediate string. The amount of right shift is calculated by the formatting unit in dependence on the misalignment factor. In this particular example, the formatting unit right-shifts the intermediate string by a number of bytes equal to the misalignment factor. Thus, the formatting unit right-shifts the intermediate string by 3 bytes.

The amount of data to be stored at the memory address ‘0’ is calculated by the data calculation unit 222. The data calculation unit 222 is configured to calculate the amount of data nbytes to store at the calculated memory address within the memory block that will contain the initial part of the data structure (e.g. memory block 302) from the difference between the element width m and the misalignment factor. In particular, the number of bytes to store is equal to the difference between the element width m (in bytes) and the misalignment factor. Thus, in this example, the data calculation unit calculates that 1 byte of data is to be stored at memory address ‘0’.

The load/store unit 220 then selects the least significant nbytes worth of data from the shifted intermediate binary string to write to the memory address ‘0’.

The data read from register 308 during the data read operation 0 is then stored in buffer 214 for use in a subsequent data store operation.

At step 814, the counter value i is incremented to i=1.

At step 816, it is determined that the counter value has not exceeded the bounding value of n=2, and so the process returns to step 806.

At step 806, the address unit 208 calculates a second memory address, denoted address 1. This address is calculated in the same manner as address 1 described above with reference to FIG. 5, and is shown in FIG. 3.

At step 808, it is determined that i does not equal n, and so the process proceeds to step 810.

At step 810, the memory unit performs data read operation i (i.e. data read operation to read a data value from another register. The register number is calculated from: 1) the base register number indicated by the instruction 700; 2) the incremental counter value.

In this example, the incremental counter value increments the previously calculated registered number by 1.

In the current example, the second register is identified as register 310 shown in FIG. 3.

At step 812, the load/store unit 220 of the memory unit 210 performs a data store operation i (i.e. data store operation 1 at this iteration) at generated address i (i.e. generated address 1 at this iteration) to store data read from the registers into the memory 204.

That is, the load/store unit performs a data store operation to access the memory block containing the generated memory address i (which in the first iteration is block 304), and write data from the registers to that generated memory address.

As illustrated in FIG. 9, to perform the data store operation 1, the load/store unit uses the data value read from the registers from the current read operation 1, and the data stored in the buffer 214 from the previous data read operation 0. A portion of this combined data is then written memory address 1. That portion is determined by the data calculation unit and the formatting unit.

The formatting unit 224 concatenates the data value read from the register for the current read operation 1, and the data stored in the buffer 214 from the previous data read operation 0 to form the intermediate binary string denoted 904. A portion of this data (denoted 906) is then written to memory address 1.

To determine the data portion 906, the formatting unit 224 right-shifts the intermediate string 904 by a number of bytes equal to the misalignment factor (i.e., 3 bytes in this example).

The load/store unit 220 then selects the nbytes least significant bytes of the shifted intermediate string to write to memory address 1. The value of nbytes is determined by the data calculation unit 222. For calculated addresses within memory blocks that will store an intermediate portion of the data structure (e.g. memory block 304), the data calculation unit calculates the value of nbytes as equal to the memory block width. Thus, the data calculation unit calculates that 4 bytes of data are to be stored at memory address 1.

The load/store unit 220 then selects the least significant nbytes worth of data from the shifted intermediate binary string to write to memory address 1.

The data read from register 310 during data read operation 1 is then stored in buffer 214 for use in a subsequent data store operation.

At step 814, the counter value i is incremented to i=2.

At step 816, it is determined that the counter value has not exceeded the bounding value of n=2, and so the process returns to step 806.

At step 806, the address unit 208 calculates a third memory address, denoted address 2. This address is calculated in the same manner as address 2 described above with reference to FIG. 5, and is shown in FIG. 3.

At step 808, it is determined that i does equal n, and so the process skips step 810 and proceeds to step 812.

At step 812, the load/store unit 220 of the memory unit 210 performs a data store operation i (i.e. data store operation 2 at this iteration) at generated address i (i.e. generated address 2 at this iteration) to store data read from the registers into the memory 204.

In this final processing iteration, the data to be stored at address 2 is determined solely from the data within the buffer 214 (i.e. the data read from the register in the previous data read operation 1). This data is shown in FIG. 9 at 906.

The amount of data selected from the buffer to store at memory address ‘2’ is calculated by the data calculation unit 222. Address 2 is within the memory block that will contain the end part of the data structure (e.g. memory block 306). The data calculation unit 222 is configured to calculate the amount of data nbytes to store at the calculated memory address within the memory block that will contain the end part of the data structure from the misalignment factor. In particular, the number of bytes to store is equal to the misalignment factor. Thus, in this example, the data calculation unit calculates that 3 bytes of data are to be stored at memory address ‘2’.

The load/store unit then selects the 3 least significant bytes of data from the buffer and writes this data to memory address ‘2’.

The three data store operations therefore cause the two data elements stored in the registers 308 and 310 to be written to memory 204 as a consecutive sequence of unaligned data elements.

In summary, the processor performs n+1 processing iterations in response to decoding an unaligned data store instruction indicating that n consecutive unaligned data elements are to be stored in memory 204. The address unit 208 generates a memory address for the memory 204 during each processing iteration (i.e. it generates a set of n+1 memory addresses). Each generated address is within a respective memory block of the memory 204 containing a portion of the data structure. The set of n+1 addresses are generated so that only one of the addresses is unaligned with the block boundaries of the memory. That address is the address within the memory block containing the initial part of the unaligned data structure (i.e. the address generated during the first processing iteration), and is generated from the base memory address and fixed offset indicated by the instruction.

The remaining generated addresses (i.e. addresses 2-n+1) are aligned with the block boundaries of the memory 204, and are generated from: 1) the base memory address indicated by the instruction; 2) the fixed memory offset indicated by the instruction; 3) an incremental memory offset calculated using the element width m and counter value; and 4) the misalignment factor.

The memory unit 210 performs a data store operation to memory 204 during each processing iteration (i.e. a set of n+1 data store operations are performed). Each data store operation is performed at a respective generated address. The memory unit calculates the amount of data to be stored at each address. For the generated memory address within the memory block that will store the beginning of the data structure (memory block 302 in the above example), the amount of data is calculated in dependence on the data element width m and the misalignment factor. For the generated memory address within the memory block that will store the end of the data structure (memory block 306 in the above example), the amount of data is calculated from the misalignment factor. For each of the remaining generated addresses (i.e. the generated addresses within memory blocks that will contain intermediate portions of the data structure-memory block 304 in the above example), the amount of data stored is equal to the memory block width.

For each processing iteration apart from the final processing iteration, the memory unit 210 performs a data read operation to read a data value from a respective register prior to performing the data store operation for that processing iteration. After the data store operation has been performed, the data value read from the register is stored in a buffer for use in a subsequent data store operation (i.e. a data store operation performed in a subsequent processing iteration). A set of n data read operations are therefore performed. The memory unit therefore reads a respective data element from n registers, so that each register stores one data element of the n consecutive data elements to be stored. The final processing iteration is the iteration that stores in a memory block the end part of the data structure (i.e. the end part of the n'th consecutive unaligned data element).

Each data store operation subsequent to the initial data store operation writes to a corresponding generated memory address a portion of data that comprises data stored in the buffer from the previous data store operation. In other words, the data store operation for each processing iteration subsequent to the initial processing iteration writes a portion of data to a generated memory address that comprises data written to the buffer during the previous processing iteration.

Storing the data read from the registers in a buffer for use in a subsequent processing iteration conveniently enables a data structure formed of n consecutive unaligned data elements to be stored in memory from n registers using only n+1 data accesses to the memory. Moreover, a computer architecture which contains both an unaligned data store instruction and an aligned data store instruction can benefit from improved flexibility in implementing the unaligned data store instruction in hardware. The unaligned data store instruction can be invoked by software only in the cases where the program cannot guarantee that the memory address is aligned. Typically, this may be relatively infrequently. Knowing that unaligned data store instructions may be called relatively infrequently, hardware can choose to implement the unaligned data store instruction in a way that requires extra cycles (e.g., processing iterations) to execute relative to the aligned case, knowing that these extra cycles do not need to be expended frequently (in particular, they do not need to be expended for the (typically) more common case where the access is aligned and known to the program being executed to be aligned). Allowing the explicitly unaligned case to consume extra cycles may allow implementations to use less area in silicon and consume less power than if the hardware had to consider the possibility that accesses might be unaligned, while still taking the least possible cycles to execute the cases that turn out to be aligned. For instance, a pipelined CPU might always schedule the execution of an unaligned data store instruction to take n+1 iterations, even though aligned accesses could in principle be completed in n iterations. This might be beneficial because the pipeline has not read the register containing the base address of the access (to find out whether the access is aligned) in time to use that information to decide whether n or n+1 iterations will be required.

The examples described herein have been explained with reference to UALWM and UASWM instructions which access 4 byte (32 bit) data elements. It would also be possible to design equivalent instructions which operate on different data element sizes, for example 8, 16, 32, or 64 bytes. Moreover, though in the examples described herein the width of the memory blocks are equal to the width of the data elements, this need not be the case. In other examples, the memory block size may be greater or smaller than the data element size.

The processor of FIG. 2 is shown as comprising a number of functional blocks.

This is schematic only and is not intended to define a strict division between different logic elements of such entities. Each functional block may be provided in any suitable manner. It is to be understood that intermediate values described herein as being formed by a unit need not be physically generated by the unit at any point and may merely represent logical values which conveniently describe the processing performed by the unit between its input and output.

The units described herein may be embodied in hardware on an integrated circuit. The units described herein may be configured to perform any of the methods described herein. Generally, any of the functions, methods, techniques or components described above can be implemented in software, firmware, hardware (e.g., fixed logic circuitry), or any combination thereof. The terms “module,” “functionality,” “component,” “element,” “unit,” “block,” and “logic” may be used herein to generally represent software, firmware, hardware, or any combination thereof. In the case of a software implementation, the module, functionality, component, element, unit, block, or logic represents program code that performs the specified tasks when executed on a processor. The algorithms and methods described herein could be performed by one or more processors executing code that causes the processor(s) to perform the algorithms/methods. Examples of a computer-readable storage medium include a random-access memory (RAM), read-only memory (ROM), an optical disc, flash memory, hard disk memory, and other memory devices that may use magnetic, optical, and other techniques to store instructions or other data and that can be accessed by a machine.

The terms computer program code and computer readable instructions as used herein refer to any kind of executable code for processors, including code expressed in a machine language, an interpreted language or a scripting language. Executable code includes binary code, machine code, bytecode, code defining an integrated circuit (such as a hardware description language or netlist), and code expressed in a programming language code such as C, Java or OpenCL. Executable code may be, for example, any kind of software, firmware, script, module or library which, when suitably executed, processed, interpreted, compiled, executed at a virtual machine or other software environment, cause a processor of the computer system at which the executable code is supported to perform the tasks specified by the code.

A processor, computer, or computer system may be any kind of device, machine or dedicated circuit, or collection or portion thereof, with processing capability such that it can execute instructions. A processor may be any kind of general purpose or dedicated processor, such as a CPU, GPU, System-on-chip, state machine, media processor, an application-specific integrated circuit (ASIC), a programmable logic array, a field-programmable gate array (FPGA), or the like. A computer or computer system may comprise one or more processors.

It is also intended to encompass software which defines a configuration of hardware as described herein, such as HDL (hardware description language) software, as is used for designing integrated circuits, or for configuring programmable chips, to carry out desired functions. That is, there may be provided a computer readable storage medium having encoded thereon computer readable program code in the form of an integrated circuit definition dataset that when processed (i.e. run) in an integrated circuit manufacturing system configures the system to manufacture a processor configured to perform any of the methods described herein, or to manufacture a processor comprising any apparatus described herein. An integrated circuit definition dataset may be, for example, an integrated circuit description.

Therefore, there may be provided a method of manufacturing, at an integrated circuit manufacturing system, a processor as described herein. Furthermore, there may be provided an integrated circuit definition dataset that, when processed in an integrated circuit manufacturing system, causes the method of manufacturing a processor to be performed.

An integrated circuit definition dataset may be in the form of computer code, for example as a netlist, code for configuring a programmable chip, as a hardware description language defining hardware suitable for manufacture in an integrated circuit at any level, including as register transfer level (RTL) code, as high-level circuit representations such as Verilog or VHDL, and as low-level circuit representations such as OASIS (RTM) and GDSII. Higher level representations which logically define hardware suitable for manufacture in an integrated circuit (such as RTL) may be processed at a computer system configured for generating a manufacturing definition of an integrated circuit in the context of a software environment comprising definitions of circuit elements and rules for combining those elements in order to generate the manufacturing definition of an integrated circuit so defined by the representation. As is typically the case with software executing at a computer system so as to define a machine, one or more intermediate user steps (e.g. providing commands, variables etc.) may be required in order for a computer system configured for generating a manufacturing definition of an integrated circuit to execute code defining an integrated circuit so as to generate the manufacturing definition of that integrated circuit.

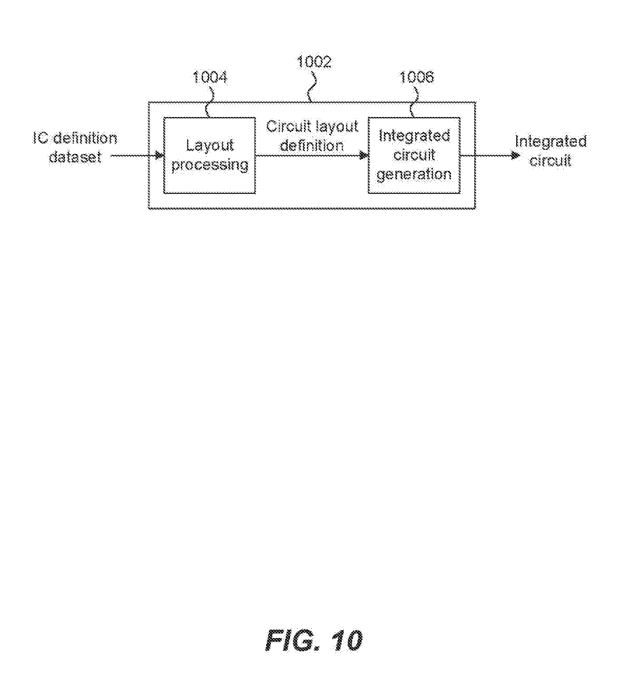

An example of processing an integrated circuit definition dataset at an integrated circuit manufacturing system so as to configure the system to manufacture a processor will now be described with respect to FIG. 10.

FIG. 10 shows an example of an integrated circuit (IC) manufacturing system 1002 which is configured to manufacture a processor as described in any of the examples herein. In particular, the IC manufacturing system 1002 comprises a layout processing system 1004 and an integrated circuit generation system 1006. The IC manufacturing system 1002 is configured to receive an IC definition dataset (e.g. defining a processor as described in any of the examples herein), process the IC definition dataset, and generate an IC according to the IC definition dataset (e.g. which embodies a processor as described in any of the examples herein). The processing of the IC definition dataset configures the IC manufacturing system 1002 to manufacture an integrated circuit embodying a processor as described in any of the examples herein.

The layout processing system 1004 is configured to receive and process the IC definition dataset to determine a circuit layout. Methods of determining a circuit layout from an IC definition dataset are known in the art, and for example may involve synthesizing RTL code to determine a gate level representation of a circuit to be generated, e.g. in terms of logical components (e.g. NAND, NOR, AND, OR, MUX and FLIP-FLOP components). A circuit layout can be determined from the gate level representation of the circuit by determining positional information for the logical components. This may be done automatically or with user involvement in order to optimize the circuit layout. When the layout processing system 1004 has determined the circuit layout, it may output a circuit layout definition to the IC generation system 1006. A circuit layout definition may be, for example, a circuit layout description.

The IC generation system 1006 generates an IC according to the circuit layout definition, as is known in the art. For example, the IC generation system 1006 may implement a semiconductor device fabrication process to generate the IC, which may involve a multiple-step sequence of photo lithographic and chemical processing steps during which electronic circuits are gradually created on a wafer made of semiconducting material. The circuit layout definition may be in the form of a mask which can be used in a lithographic process for generating an IC according to the circuit definition. Alternatively, the circuit layout definition provided to the IC generation system 1006 may be in the form of computer-readable code which the IC generation system 1006 can use to form a suitable mask for use in generating an IC.

The different processes performed by the IC manufacturing system 1002 may be implemented all in one location, e.g. by one party. Alternatively, the IC manufacturing system 1002 may be a distributed system such that some of the processes may be performed at different locations, and may be performed by different parties. For example, some of the stages of: (i) synthesizing RTL code representing the IC definition dataset to form a gate level representation of a circuit to be generated, (ii) generating a circuit layout based on the gate level representation, (iii) forming a mask in accordance with the circuit layout, and (iv) fabricating an integrated circuit using the mask, may be performed in different locations and/or by different parties.

In other examples, processing of the integrated circuit definition dataset at an integrated circuit manufacturing system may configure the system to manufacture a processor without the IC definition dataset being processed so as to determine a circuit layout. For instance, an integrated circuit definition dataset may define the configuration of a reconfigurable processor, such as an FPGA, and the processing of that dataset may configure an IC manufacturing system to generate a reconfigurable processor having that defined configuration (e.g. by loading configuration data to the FPGA).

In some embodiments, an integrated circuit manufacturing definition dataset, when processed in an integrated circuit manufacturing system, may cause an integrated circuit manufacturing system to generate a device as described herein. For example, the configuration of an integrated circuit manufacturing system in the manner described above with respect to FIG. 10 by an integrated circuit manufacturing definition dataset may cause a device as described herein to be manufactured.

In some examples, an integrated circuit definition dataset could include software which runs on hardware defined at the dataset or in combination with hardware defined at the dataset. In the example shown in FIG. 10, the IC generation system may further be configured by an integrated circuit definition dataset to, on manufacturing an integrated circuit, load firmware onto that integrated circuit in accordance with program code defined at the integrated circuit definition dataset or otherwise provide program code with the integrated circuit for use with the integrated circuit.

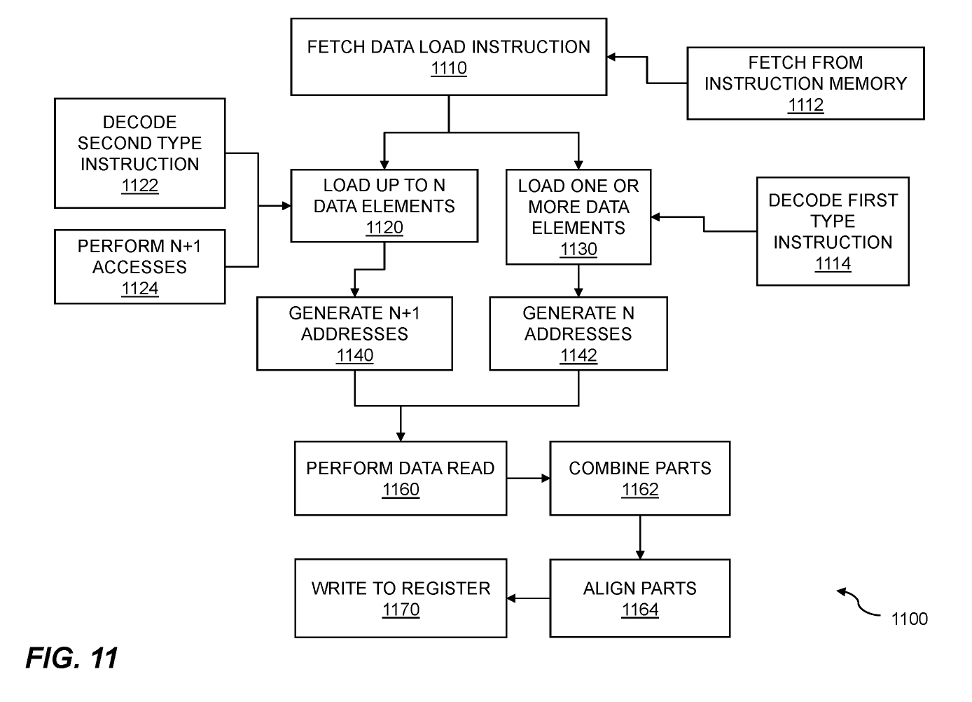

FIG. 11 is a flow diagram for loading data elements from a memory. The loading can be based on unaligned memory accesses, where the unaligned memory accesses are unaligned with word boundaries, double word boundaries, block boundaries, and the like. In embodiments, the memory from which the data elements are loaded includes a memory containing data blocks separated by block boundaries. The loading data elements can be accomplished using a processor configured to implement an instruction set architecture (ISA). The ISA can include multiple types of load instructions. In embodiments, the ISA includes a first type of data load instruction for loading an aligned data structure from the memory, and a second type of data load instruction for loading from the memory an unaligned data structure. As stated throughout, data structures can be aligned to a boundary such as a block boundary, or can be unaligned to a boundary.

The flow 1100 includes fetching a data load instruction 1110 of the first type or the second type. A data load instruction of the second type can include an instruction for loading from the memory an unaligned data structure. The data load instruction can be loaded from a memory such as a program memory, a register such as an instruction register, and so on. The flow 1100 includes fetching instructions from an instruction memory 1112. The instruction memory can be within a processing element, can be coupled to or in communication with the processing element, etc. The instruction that is fetched can be decoded to determine what type of instruction it is, such as a data transfer instruction (e.g. load, store), a data manipulation instruction, a program control instruction, etc. The flow 1100 includes decoding fetched instructions of a first type 1114 and identifying an instruction as an instruction of the first type in response to decoding a bit pattern of opcode bits identifying the instruction as an instruction of the first type. The decoding can decode the bit pattern of opcode bits to identify an instruction of the first type, or another type of instruction such as a data manipulation instruction or a program control instruction. In response to fetching and decoding an instruction of the second type 1122, the flow 1100 includes loading from the memory a data structure formed of up to n consecutive data elements 1120 determined from the data load instruction. The data elements that are loaded can be aligned data elements or unaligned data elements. In embodiments, the data structure loaded from memory is formed of n consecutive unaligned data elements. In response to fetching the data load instruction of the second type, the flow 1100 includes performing n+1 memory accesses 1124 to load the data structure formed of n consecutive data elements. Other data load instructions can be used for loading the data. In response to fetching a data load instruction of the first type 1114, the flow 1100 includes loading from the memory a data structure formed of one or more consecutive aligned data elements 1130. The aligned data structures can be aligned to words or double words or other suitable architectural alignment boundaries. In embodiments, the aligned data elements are aligned to block boundaries. A memory access can be an aligned memory access or an unaligned memory access. In embodiments, each memory access apart from the first access and last access is an aligned memory access.

In response to fetching a data load instruction of the second type, the flow 1100 includes generating a set of n+1 memory addresses 1140 of the memory, each corresponding to a respective data block of the memory containing a part of the data structure. The memory addresses also could make references to other portions of memory such as word addresses, double word addresses, and the like. The memory addresses may be aligned or unaligned. In embodiments, one of the n or n+1 generated memory addresses can be unaligned with the block boundaries of the memory. While the one generated memory address can be unaligned, in other embodiments, each of the remaining memory addresses can be aligned with the block boundaries of the memory. Alignment with block boundaries of the memory can improve memory access efficiency for loading or storing. Other techniques can be used to generate a set of memory addresses. In response to fetching a data load instruction of the first type, the flow 1100 includes generating a set of n memory addresses 1142 of the memory, each corresponding to a respective data block of the memory containing a part of the data structure. Some embodiments comprise, in response to fetching a data load instruction of the second type: generating a set of n+1 memory addresses of the memory each corresponding to a respective data block of the memory containing a part of the data structure; performing, at each generated memory address, a data read to read part of the data structure within the data block of the memory corresponding to that generated memory address; and performing a set of n+1 load operations and writing n data elements formed from the read parts of the data structure into registers.

In embodiments, the generating includes generating the memory address corresponding to the data block of the memory containing the initial part of the data structure. The generating the memory address can include using: i) a base address contained in a register indicated by the fetched data load instruction; and ii) a fixed address offset indicated by the fetched data load instruction. The register containing the base or reference address can include a pointer register, a global pointer register, and the like. The fixed address offset can refer to a block, an offset within a block, etc. In other embodiments, the generating includes generating each of the remaining memory addresses further in dependence on: iii) an incremental address offset; and iv) the misalignment between the data structure and the block boundaries of the memory. The remaining memory addresses can include the base address plus or minus the offset address such as address=base address+/−offset address. The misalignment may similarly be calculated such as address=block boundary address+/−misalignment.

The flow 1100 further includes calculating the amount of data to read from the data block of the memory corresponding to each generated memory address (generated n+1 addresses 1140 and generated n addresses 1142). The amount of data to read can be based on units, where the units can include bytes, fractions of words such as half words, words, double words, or the like. The data can be included within a block of memory, where a block of memory can include a number of bytes such as 8 kilobytes (KB), 16 KB, 32 KB, 64 KB, and so on. The amount calculated of data to read can include a portion of a block, a block, multiple blocks, etc.

The flow 1100 includes performing, at each generated memory address, a data read 1160 to read the part of the data structure within the data block of the memory corresponding to that generated memory address. The data read can include reading a byte, a half word, a word, a double word, or other amount of data addressed by the generated memory address. Various techniques can be used to keep track of which data read is being performed at which generated memory address. In embodiments, the data load instruction of the second type comprises a count field indicating the number n of data elements to be loaded from the memory. The reading can include reading from a data block in parts, segments, partitions, and the like. In embodiments, the reading can include reading from the data block of the memory containing the initial part of the data structure a number of bits determined from the difference between the width of the data element and the misalignment between the data structure and the block boundaries of the memory. The misalignment can include a “distance” or number of addresses between the data structure and the block boundaries in the memory. The reading can further include reading from the data block of the memory containing the end part of the data structure a number of bits determined from the misalignment between the data structure and the block boundaries of the memory. Intermediate portions of the data structure may also be read. In embodiments, the reading can include reading all the bits of the blocks of the memory containing intermediate parts of the data structure. The flow 1100 includes combining the parts 1162 of the data structure read from the generated memory addresses and aligning 1164 the combined parts with the block boundaries to form the n data elements to be loaded into the registers. Since a given read operation from a generated address in memory may retrieve a unit or part such as a byte, multiple parts that are read can be combined to form larger units such as half words, words, double words, or other units. The combined parts may be aligned at block boundaries to increase storage efficiency, to increase data access speed, and so on.

A data load instruction includes reading data from a data structure in memory and storing data into registers. Recalling that the read data can be combined and aligned, as discussed previously, each store operation can store in a register a data element formed from a combination of: i) the part of the data structure read in a most recent data read operation; and ii) the part of the data structure stored in the buffer from a previous data read operation. The flow 1100 includes performing a set of n+1 store operations, such that n data elements formed from the read parts of the data structure are written into registers 1170. The registers can be internal to a processor configured to implement an instruction set architecture, can be shared between or among processors, can be global registers, and so on. The storing can include storing each of the n data elements formed from the read parts of the data structure in a respective register. The storing of each of the n data elements can be performed element by element, based on combined and aligned parts, etc. In embodiments, the storing can include storing each of the n data elements formed from the read parts of the data structure in n sequentially numbered registers. The storing can include storage techniques other than using sequentially numbered registers. In embodiments, the storing can include storing each of the n data elements in a respectively numbered register calculated in dependence on: i) a base register number indicated by the fetched instruction; and ii) an incremental counter value. Recall that the data elements that are stored may be a different size from the amount of data that is obtained from each read operation. In embodiments, after performing each data read operation, the flow can include storing the part of the data structure read in that data read operation to a buffer for use in a subsequent store operation. When the buffer is full, or based on other criteria such as a number of units of data, the store operation can be performed. In embodiments, each store operation stores in a register a data element formed from a combination of: i) the part of the data structure read in a most recent data read operation; and ii) the part of the data structure stored in the buffer from a previous data read operation.

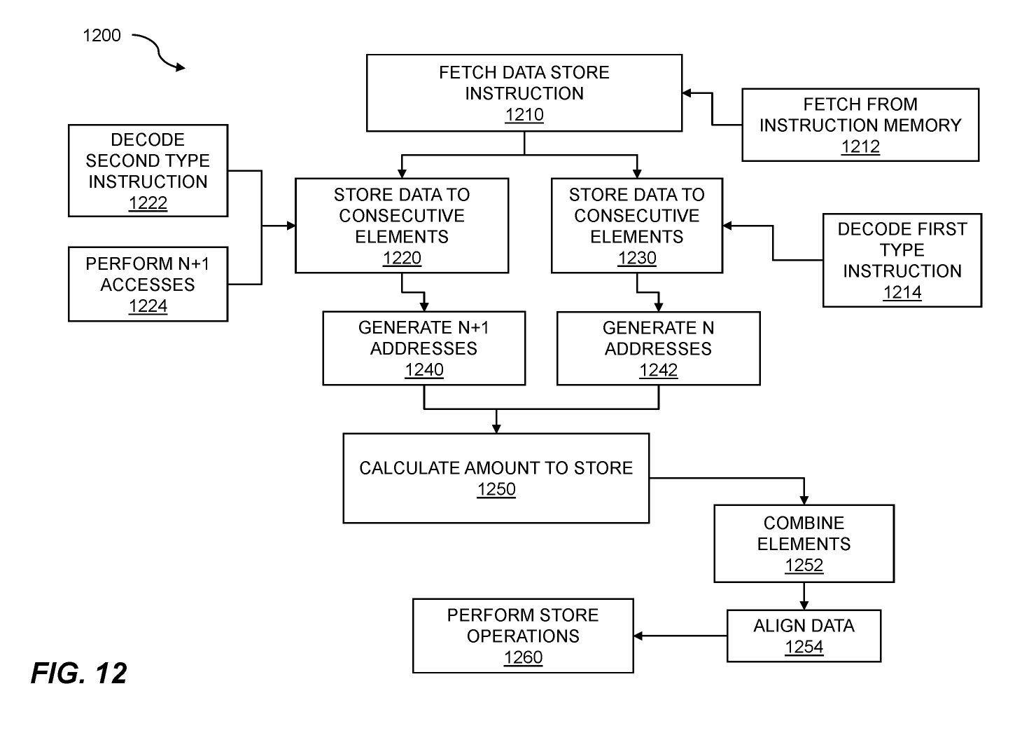

FIG. 12 is a flow diagram for storing a set of registers to a memory. The storing, such as the storing of data, can be based on unaligned memory accesses, where the unaligned memory accesses are unaligned with storage block boundaries or other boundaries. In embodiments, the memory to which the set of registers are loaded includes memory which contains data blocks that are separated or delineated by block boundaries. The storing a set of registers can be accomplished using a processor configured to implement an instruction set architecture (ISA). The ISA can include multiple types of store instructions. In embodiments, the ISA includes a first type of data store instruction for storing in the memory an aligned data structure, and a second type of data store instruction for storing in the memory an unaligned data structure. Recall that data structures can be aligned to a boundary such as a block boundary, or can be unaligned to a boundary.

The flow 1200 includes fetching a data store instruction 1210 of the first type or the second type. A data store instruction of the second type can include an instruction for storing from a set of registers to the memory, where the storing can be to an unaligned data structure in memory. The data store instruction can be fetched from a memory such as a program memory, a register such as an instruction register, and so on. The flow 1200 includes fetching instructions from an instruction memory 1212. The instruction memory can be within a processing element, can be coupled to or in communication with the processing element, etc. The instruction that is fetched can be decoded, where the decoding determines the kind of instructions, such as data transfer, data manipulation, or program control, or type of instruction, such as a first type instruction, a second type instruction, etc. The flow 1200 includes decoding fetched instructions and identifying an instruction as a data store instruction of the second type 1222 in response to decoding a bit pattern of opcode bits identifying the instruction as a data store instruction of the second type. The decoding can decode an opcode bit pattern to identify an instruction of the first type. In response to fetching and decoding an instruction of the second type 1222, the flow 1200 includes storing in the memory data from registers of the set of registers determined from the data store instruction as a data structure of n consecutive data elements 1220. The data elements that are loaded can be aligned data elements or unaligned data elements. In embodiments, the data structure stored in memory is formed of n consecutive unaligned data elements. In response to fetching the data store instruction of the second type, performing n+1 memory accesses 1224 stores in the memory the data from the registers as a data structure of n consecutive data elements. Other data store instructions can be used for storing data from registers to memory. In response to fetching a data store instruction of the first type 1214, the flow 1200 includes storing in the memory data from registers of the set of registers as a data structure formed of one or more consecutive aligned data elements 1230. As discussed throughout, the aligned data elements can be aligned to words or double words, blocks, etc. A memory access can be an aligned memory access or an unaligned memory access. In embodiments, each memory access apart from the first access is an aligned memory access.

Each register within the set of registers can store a data element. In response to a data store instruction of the second type being fetched for storing, in the memory, a data structure formed of n consecutive unaligned data elements, the flow 1200 includes generating a set of n+1 memory addresses 1240 each residing in a respective block of the memory. The memory addresses may be aligned or unaligned. In embodiments, one of the n generated memory addresses can be unaligned with the block boundaries of the memory. While the one generated memory address can be unaligned with a block boundary, in other embodiments, each of the remaining memory addresses can be aligned with the block boundaries of the memory. Other techniques can be used to generate a set of memory addresses. In response to a data store instruction of the first type being fetched for storing, in the memory, a data structure formed of n consecutive unaligned data elements, the flow 1200 includes generating a set of n memory addresses 1242 each residing in a respective block of the memory. In embodiments, one of the generated n+1 memory addresses is unaligned with block boundaries of the memory.

In embodiments, the generating includes generating the memory address corresponding to the block of the memory to store the initial part of the data structure using: i) a base address in a register indicated by the fetched data store instruction; and ii) a fixed address offset indicated by the fetched data store instruction. The register containing the base address can include a pointer register, a global pointer register, etc. The fixed address offset can refer to an offset from a block boundary, an offset within a block, etc. In other embodiments, the generating includes generating each of the remaining memory addresses further in dependence on: iii) an incremental address offset; and iv) the misalignment between the data structure and the block boundaries of the memory. The flow 1200 further includes calculating the amount of data to store 1250 at each generated memory address. The amount of data to store can be based on units such as bytes, words, etc. The data can be stored to a block of memory, where a block of memory can include a number of kilobytes, such as a power of two. The amount calculated of data to store can include a portion of a block, a block, multiple blocks, etc.

The flow 1200 includes combining the element 1252 of the data structure and aligning data 1254 of the combined parts with the block boundaries to form the n data elements to be stored from the registers into memory. Since a given store operation from registers may retrieve a unit or part such as a byte, multiple parts that are read can be combined to form larger units such as half words, words, double words, or some other unit. The combined parts may be aligned at block boundaries to increase storage efficiency, to increase data access speed, and so on. The flow 1200 includes performing a set of n+1 store operations 1260 each at a respective generated memory address to store in the memory the data elements from n registers as a data structure of n unaligned data elements. The unaligned data elements can be based on units including bytes, words, and the like. Various techniques can be used to keep track of which store operation is being performed at which generated memory address. In embodiments, the fetched data store instruction of the second type comprises a count field indicating the number n of data elements to be stored in the memory. The storing can include storing to a portion of a block, a block, a plurality of blocks, etc. The storing can be based on storing in the memory the data elements from n consecutively numbered registers. The storing can be based on numbered registers.

In embodiments, the storing includes storing in the memory each of n data elements from a respective numbered register calculated in dependence on: i) a base register number indicated by the fetched data store instruction; and ii) an incremental counter value. The storing can be performed in parts. In embodiments, the storing includes storing, at the generated memory address within the memory block to store the initial part of the data block, an amount of data determined from the difference between the width of the data element and the misalignment between the data block and the block boundaries of the memory. The misalignment can be based on a difference in a number of units such as bytes of the data element compared to the number of units at a given memory address. Other portions or parts of the data structure can be stored.

In embodiments, the storing can include storing, at the generated memory address within the memory block to store the end part of the data structure, an amount of data determined from the misalignment between the data structure and the block boundaries of the memory. Intermediate portions of the data structure may also be stored. In embodiments, the storing can include storing an amount of data equal to the memory block width at each generated memory address within a memory block to store an intermediate part of the data structure. Prior to a given store operation, a data element from a register may be stored or held in a buffer. The memory unit, which can be associated with the processing unit, can be configured to, prior to each store operation apart from the final store operation that stores in the corresponding block of memory the end part of the data structure, read a data element from a respective register, and store that data element in a buffer after the store operation for use in a subsequent data store operation. The subsequent data store operation can be the next operation, a later operation, and so on. The flow 1200 includes combining the data element 1252 read from the respective register for said store operation with the data in the buffer from the previous store operation. The data may align with a memory address or may not align with the memory address. The flow 1200 further includes, prior to writing the portion of combined data, aligning the combined data elements 1252 with the corresponding generated memory address in dependence on the misalignment between the data structure and the block boundaries in memory. The combined and aligned data may be stored or written to memory. The flow 1200 includes writing a portion of the combined data to perform a store operation 1260 at the corresponding generated memory address. The writing can include writing a block of data to a memory block. In embodiments, a memory unit is configured to, prior to each store operation apart from a final store operation that stores in a corresponding block of memory an end part of the data structure, read a data element from a respective register, and store that data element in a buffer after the store operation for use in a subsequent data store operation.

FIG. 13 is a system diagram for loading and storing data. The loading can include loading data elements from a memory containing data blocks separated by block boundaries. The storing can include storing data from a set of registers to a memory containing data blocks separated by block boundaries. The loading or the storing can use a processor configured to implement an instruction set architecture (ISA). The ISA can include a first type of data load instruction for loading an aligned data structure from the memory, and a second type of data load instruction for loading from the memory an unaligned data structure. The ISA can further include a first type of data store instruction for storing in the memory an aligned data structure, and a second type of data store instruction for storing in the memory an unaligned data structure. The system 1300 can include one or more processors 1310 coupled to a memory 1312 which stores instructions. The system 1300 can include a display 1314 coupled to the one or more processors 1310 for displaying data, intermediate steps, instructions, program counters, instruction counters, control signals, pointer values, global pointer values, stack values, stack frame values, and so on. In embodiments, one or more processors 1310 are attached to the memory 1312 where the one or more processors, when executing the instructions which are stored, are configured to load data elements from a memory containing data blocks separated by block boundaries using a processor configured to implement an instruction set architecture that includes a first type of data load instruction for loading an aligned data structure from the memory and a second type of data load instruction for loading an unaligned data structure from the memory, wherein the load of data elements comprises: fetching a data load instruction of the second type; and loading from the memory according to the data load instruction of the second type, wherein a data structure formed of n consecutive data elements is determined from the data load instruction.

In further embodiments, one or more processors 1310 are attached to the memory 1312 where the one or more processors, when executing the instructions which are stored, are configured to: store data elements from a set of registers to a memory containing data blocks separated by block boundaries using a processor configured to implement an instruction set architecture that includes a first type of data store instruction for storing in the memory an aligned data structure and a second type of data store instruction for storing in the memory an unaligned data structure, wherein the storing of data elements comprises: fetching a data store instruction of the second type; and storing in the memory according to the data store instruction of the second type, wherein the data from registers of the set of registers is determined from the data store instruction to be a data structure of n consecutive data elements.

The system 1300 can include a collection of instructions and data 1320. The instructions and data 1320 may be stored in a database, one or more statically linked libraries, one or more dynamically linked libraries, precompiled headers, source code, or other suitable formats. The instructions can include instructions for loading data elements from a memory containing data blocks; or instructions for storing data from a set of registers to memory containing data blocks. The processing apparatus may include processing elements within a reconfigurable fabric. The system 1300 can include a fetching component 1330. The fetching component can include functions and instructions for fetching a data load instruction of the second type; fetching a data load instruction of the first type; fetching a data store instruction of the second type; or fetching a data store instruction of the first type. In addition to functions and instructions for fetching data load or data store instructions, the fetching component can include functions and instructions for fetching other types of instructions such as data manipulation instructions, program control instructions, and so on. The instructions can include instructions for processing data, analyzing data, comparing data, and so on.

The system 1300 can include a loading/storing component 1340. The loading/storing component can include functions and instructions for loading from the memory a data structure; or storing in the memory data from registers of a set of registers. The loading from memory can include the two types of load instructions. In response to an instruction of the second type, the loading can include loading from the memory a data structure formed of n consecutive data elements determined from the data load instruction. In response to an instruction of the first time, the loading can include loading from the memory a data structure formed of one or more consecutive aligned data elements. The aligned data elements can be aligned to various boundaries including a byte, a fraction of a word such as a half word, a word, a double word, and so on. The storing to memory can include the two types of store instructions. In response to an instruction of the second type, the storing can include storing in the memory data from registers of the set of registers determined from the data store instruction as a data structure of n consecutive data elements. The consecutive data elements can include bytes, words, double words, etc. In response to an instruction of the first type, the storing can include storing in the memory data from registers of the set of registers as a data structure formed of one or more consecutive aligned data elements. The aligned data elements can be aligned to word boundaries, double word boundaries, block boundaries, and the like.

The system 1300 can include a generating component 1350. The generating component can include functions and instructions for generating memory addresses. The addresses that are generated can be based on the type of load instruction or the type of store instruction. In response to fetching a data load instruction of the second type, the generating can include generating a set of n+1 memory addresses of the memory each corresponding to a respective data block of the memory containing a part of the data structure. In embodiments, one of the n+1 generated memory addresses can be unaligned with the block boundaries of the memory. The alignment could also be with words, double words, etc. Other techniques for generating can be used. In embodiments, the generating can include generating the memory address corresponding to the data block of the memory containing the initial part of the data structure. The generating can include using a base address contained in a register indicated by the fetched data load instruction; or a fixed address offset indicated by the fetched data load instruction. Remaining addresses can also be generated. In embodiments, the generating includes generating each of the remaining memory addresses further in dependence on: an incremental address offset; and the misalignment between the data structure and the block boundaries of the memory.

The generating can also apply to the storing instructions. In response to a data store instruction of the second type being fetched for storing, in the memory, a data structure formed of n consecutive unaligned data elements, generating a set of n+1 memory addresses each residing in a respective block of the memory. Some of the generated addresses may be unaligned while other generated addresses may be aligned. In embodiments, one of the generated n+1 memory addresses can be unaligned with the block boundaries of the memory. Each of the remaining generated memory addresses can be aligned with the block boundaries of the memory. Other memory addresses can be generated for the storing. The generating can include generating the memory address corresponding to the block of the memory to store the initial part of the data structure using: a base address in a register indicated by the fetched data store instruction; or a fixed address offset indicated by the fetched data store instruction. The remaining memory addresses can also be generated. The generating can include generating each of the remaining memory addresses further in dependence on: an incremental address offset; and the misalignment between the data structure and the block boundaries of the memory.

The system 1300 can include a performing component 1360. The performing component can include functions and instructions for performing memory accesses. The memory accesses that are performed can be dependent on the type of load instruction or the type of store instruction. In response to fetching the data load instruction of the second type, the performing can include performing n+1 memory accesses to load the data structure formed of n consecutive data elements. The one or more memory accesses can include memory reads or memory writes. In embodiments, the performing can include performing, at each generated memory address, a data read to read the part of the data structure within the data block of the memory corresponding to that generated memory address; and performing a set of n+1 load operations and writing n data elements formed from the read parts of the data structure into registers. The performing component can include functions and instructions for storing. The performing can include performing n+1 memory accesses to store in the memory the data from the registers as a data structure of n consecutive data elements. The storing can be aligned to a boundary such as a block boundary. The performing can include performing a set of n+1 store operations each at a respective generated memory address to store in the memory the data elements from n registers as a data structure of n unaligned data elements.

The system 1300 can include a reading/writing component 1370. The reading/writing component 1370 can include functions and instructions for reading from a data block or writing to a data block. The reading can include reading from the data block of the memory containing the initial part of the data structure a number of bits determined from the difference between the width of the data element and the misalignment between the data structure and the block boundaries of the memory. Other parts of the data structure can be read. The reading can include reading from the data block of the memory containing the end part of the data structure a number of bits determined from the misalignment between the data structure and the block boundaries of the memory. The reading can also include reading all the bits of the blocks of the memory containing intermediate parts of the data structure. The reading/writing component further includes writing to the data block. The writing can include writing a portion of the combined data at the corresponding generated memory address. The writing can be based on alignment. The writing can include, prior to writing the portion of combined data, aligning the combined data with the corresponding generated memory address in dependence on the misalignment between the data structure and the block boundaries in memory.

The system 1300 can include a computer program product embodied in a non-transitory computer readable medium for processor instruction manipulation, the computer program product comprising code which causes one or more processors to perform operations of: loading data elements from a memory containing data blocks separated by block boundaries using a processor configured to implement an instruction set architecture that includes a first type of data load instruction for loading an aligned data structure from the memory and a second type of data load instruction for loading an unaligned data structure from the memory, wherein the loading comprises: fetching a data load instruction of the second type; and loading from the memory according to the data load instruction of the second type, wherein a data structure formed of n consecutive data elements is determined from the data load instruction.

The system 1300 can include a computer program product embodied in a non-transitory computer readable medium for processor instruction manipulation, the computer program product comprising code which causes one or more processors to perform operations of: storing data elements from a set of registers to a memory containing data blocks separated by block boundaries using a processor configured to implement an instruction set architecture that includes a first type of data store instruction for storing in the memory an aligned data structure and a second type of data store instruction for storing in the memory an unaligned data structure, wherein the storing of data elements comprises: fetching a data store instruction of the second type; and storing in the memory according to the data store instruction of the second type, wherein the data from registers of the set of registers is determined from the data store instruction to be a data structure of n consecutive data elements.

The implementation of concepts set forth in this application in devices, apparatus, modules, and/or systems (as well as in methods implemented herein) may give rise to performance improvements when compared with known implementations. The performance improvements may include one or more of increased computational performance, reduced latency, increased throughput, and/or reduced power consumption. During manufacture of such devices, apparatus, modules, and systems (e.g. in integrated circuits) performance improvements can be traded-off against the physical implementation, thereby improving the method of manufacture. For example, a performance improvement may be traded against layout area, thereby matching the performance of a known implementation but using less silicon. This may be done, for example, by reusing functional blocks in a serialized fashion or sharing functional blocks between elements of the devices, apparatus, modules, and/or systems. Conversely, concepts set forth in this application that give rise to improvements in the physical implementation of the devices, apparatus, modules, and systems (such as reduced silicon area) may be traded for improved performance. This may be done, for example, by manufacturing multiple instances of a module within a predefined area budget.

The applicant hereby discloses in isolation each individual feature described herein and any combination of two or more such features, to the extent that such features or combinations are capable of being implemented based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”— may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method of data accessing comprising:
loading data elements from a memory containing data blocks separated by block boundaries using a processor configured to implement an instruction set architecture that includes a first type of data load instruction for loading an aligned data structure from the memory and a second type of data load instruction for loading an unaligned data structure from the memory, wherein the loading comprises:
fetching a data load instruction of the second type; and
loading from the memory according to the data load instruction of the second type, wherein a data structure formed of n consecutive data elements is determined from the data load instruction.

2. The method of claim 1 wherein the data structure loaded from memory is formed of n consecutive unaligned data elements.

3. The method of claim 1 further comprising loading from the memory a data structure formed of one or more consecutive aligned data elements in response to fetching a data load instruction of the first type.

4. The method of claim 1 further comprising performing n+1 memory accesses to load the data structure formed of n consecutive data elements in response to fetching the data load instruction of the second type.

5. The method of claim 4 wherein each memory access apart from a first access and a last access is an aligned memory access.

6. The method of claim 1 further comprising, in response to fetching a data load instruction of the second type:
generating a set of n+1 memory addresses of the memory each corresponding to a respective data block of the memory containing a part of the data structure;
performing, at each generated memory address, a data read to read part of the data structure within the data block of the memory corresponding to that generated memory address; and
performing a set of n+1 load operations and writing n data elements formed from the read parts of the data structure into registers.

7. The method of claim 6 wherein one of the n+1 generated memory addresses is unaligned with the block boundaries of the memory.

8. The method of claim 7 wherein each remaining memory address is aligned with the block boundaries of the memory.

9. The method of claim 6 further comprising storing each of the n data elements formed from the read parts of the data structure in n sequentially numbered registers.

10. The method of claim 9 further comprising storing each of the n data elements in a respective numbered register calculated in dependence on a base register number indicated by the fetched instruction and an incremental counter value.

11. The method of claim 6 further comprising generating the memory address corresponding to the data block of the memory containing an initial part of the data structure using a base address contained in a register indicated by the fetched data load instruction and a fixed address offset indicated by the fetched data load instruction.

12. The method of claim 11 further comprising generating each of remaining memory addresses further in dependence on an incremental address offset and a misalignment between the data structure and the block boundaries of the memory.

13. The method of claim 6 further comprising calculating an amount of data to read from the data block of the memory corresponding to each generated memory address.

14. The method of claim 6 further comprising combining the parts of the data structure read from the generated memory addresses and aligning the combined parts with the block boundaries to form the n data elements to be loaded into the registers.

15. The method of claim 14 further comprising reading from the data block of the memory containing an initial part of the data structure a number of bits determined from a difference between a width of the data element and a misalignment between the data structure and the block boundaries of the memory.

16. The method of claim 14 further comprising reading from the data block of the memory containing an end part of the data structure a number of bits determined from a misalignment between the data structure and the block boundaries of the memory.

17. The method of claim 14 further comprising reading all bits of the blocks of the memory containing intermediate parts of the data structure.

18. The method of claim 6 further comprising storing the part of the data structure read from a register in that data read operation to a buffer for use in a subsequent store operation after performing each data read operation.

19. The method of claim 6 wherein each store operation stores in a register a data element formed from a combination of the part of the data structure read in a most recent data read operation and the part of the data structure stored in a buffer from a previous data read operation.

20. The method of claim 1 wherein the data load instruction of the second type comprises a count field indicating a number n of data elements to be loaded from the memory.

21. The method of claim 1 further comprising:
fetching instructions from an instruction memory; and
decoding fetched instructions and identifying an instruction as an instruction of the second type in response to decoding a bit pattern of opcode bits identifying the instruction as an instruction of the second type.

22. (canceled)

23. A computer system for processor instruction manipulation comprising:
a memory which stores instructions;
one or more processors attached to the memory wherein the one or more processors, when executing the instructions which are stored, are configured to:
load data elements from a memory containing data blocks separated by block boundaries using a processor configured to implement an instruction set architecture that includes a first type of data load instruction for loading an aligned data structure from the memory and a second type of data load instruction for loading an unaligned data structure from the memory, wherein the load of data elements comprises:
fetching a data load instruction of the second type; and
loading from the memory according to the data load instruction of the second type, wherein a data structure formed of n consecutive data elements is determined from the data load instruction.

24. A processor-implemented method of data accessing comprising:
storing data elements from a set of registers to a memory containing data blocks separated by block boundaries using a processor configured to implement an instruction set architecture that includes a first type of data store instruction for storing in the memory an aligned data structure and a second type of data store instruction for storing in the memory an unaligned data structure, wherein the storing of data elements comprises:
fetching a data store instruction of the second type; and
storing in the memory according to the data store instruction of the second type, wherein the data from registers of the set of registers is determined from the data store instruction to be a data structure of n consecutive data elements.

25-46. (canceled)
